(19) United States
(12) Patent Application Publication
(10) Pub. No.: US 2012/0133683 A1
(43) Pub. Date: May 31, 2012

(54) ORGANIC EL DISPLAY APPARATUS

(75) Inventors: Tatsuhito Goden, Chiba-shi (JP); Fujio Kawano, Kawasaki-shi (JP); Noriyuki Shikina, Ichihara-shi (JP); Kiyofumi Sakaguchi, Mobara-shi (JP); Masami Iseki, Mobara-shi (JP); Takanori Yamashita, Chiba-shi (JP); Kouji Ikeda, Chiba-shi (JP)

(73) Assignee: CANON KABUSHIKI KAISHA, Tokyo (JP)

(21) Appl. No.: 13/299,940

(22) Filed: Nov. 18, 2011

(30) Foreign Application Priority Data
Nov. 25, 2010 (JP) 2010-262295

(51) Int. Cl. G09G 5/10; G09G 3/30

(52) U.S. Cl. 345/690; 345/77

(57) ABSTRACT

An organic EL display apparatus includes a plurality of pixels, organic EL devices, a data line driver, a pixel circuit, and a gate line driver. Each pixel has three or more organic EL device groups, each organic EL device group consisting of two organic EL devices emitting light of the same color; and emits light of three or more colors. The two organic EL devices are a first organic EL device having a light condensing element arranged on the light emitting surface side and a second organic EL device not having a light condensing element arranged on the light emitting surface side. Each pixel has a luminance difference forming unit for varying the luminance ratio of each color in the first organic EL device and the luminance ratio of each color in the second organic EL device.

### BACKGROUND OF THE INVENTION

1. Field of the Invention

The present invention relates to a display apparatus using an organic EL (electroluminescent) device, and more particularly to an active matrix type organic EL display apparatus capable of improving light use efficiency from the front side of the organic EL device.

2. Description of the Related Art

The organic EL device allows light to be emitted at various angles from a luminescent layer thereof, thus increasing the production of light components fully reflected on an interface between a protection layer and an external space. Some of the fully reflected light components are confined inside the device. Accordingly, the organic EL device has a problem of lower light extraction efficiency. In order to solve this problem, Japanese Patent Application Laid-Open No. 2004-039500 discloses a configuration in which a micro lens array made of a resin is provided on a silicon oxynitride (SiNxOy) film for sealing the organic EL device.

The configuration in which a micro lens array is provided on the organic EL device as disclosed in Japanese Patent Application Laid-Open No. 2004-039500 is expected to provide not only an effect of being able to extract the light components that would have been fully reflected if the micro lens array were not used, but also an effect of collecting light. These effects can contribute to improvement in front side luminance (light extraction efficiency in the front direction, namely, in the normal direction of the substrate) of the display apparatus using the organic EL device. Note that the light collecting effect of the micro lens depends on the color wavelength (R, G, and B).

Thus, chromaticity in the front direction differs depending on whether a micro lens is present or not. Accordingly, the organic EL device having a micro lens cannot obtain a desired white balance at the same luminance ratio as that of the organic EL device not having a micro lens. Thus, in order to obtain the desired white balance, the white balance needs to be adjusted by varying the ratio of the R luminance, the G luminance, and the B luminance between the organic EL device having a micro lens and the organic EL device not having a micro lens.

### SUMMARY OF THE INVENTION

In view of this, it is an object of the present invention to provide an organic EL display apparatus which is easy to adjust to a desired white balance and having a high display quality.

In order to achieve the above object, an organic EL display apparatus according to the present invention comprises: a plurality of pixels arranged in a matrix; a plurality of organic EL elements arranged in the plurality of pixels; a data line driver for supplying to each of the plurality of pixels data signal based on an image data; a plurality of pixel circuits each arranged in each of the plurality of pixels, and having a plurality of transistors for supplying to the organic EL element a driving current based on the data signal to emit light from the organic EL element; and a gate line driver for driving each of the transistors, wherein the pixel comprises three or more pairs of the organic EL elements, such that the organic EL elements paired emit light of the same color, while the organic EL elements in different pairs emit lights of the different colors, the organic EL elements paired includes a first organic EL element having at a light emitting surface side thereof a light condensing element, and a second organic EL element having at the light emitting surface side thereof no light condensing element, and a luminance ratio difference forming unit is provided for forming a difference between a luminance ratio of the first organic EL element and a luminance ratio of the second organic EL element, in each of the pairs in each of the pixels.

The present invention can vary the ratio of the R luminance, the G luminance, and the B luminance in one pixel from common image data between “a light condensing element present region” and “a light condensing element absent region”. Thus, there can be provided an organic EL display apparatus which is easy to adjust to a desired white balance and having a high display quality.

Further features of the present invention will become apparent from the following description of exemplary embodiments with reference to the attached drawings.

### BRIEF DESCRIPTION OF THE DRAWINGS

FIGS. 1A, 1B, and 1C are schematic views illustrating an organic EL panel, a pixel structure, and a pixel arrangement according to the present invention.

FIG. 2 is a graph illustrating a relation between the relative luminance and the view angle characteristics of a sub-pixel containing the organic EL device according to the present invention.

FIG. 3 is an operation timing chart for each mode of the organic EL panel according to the present invention.

FIG. 4 is a graph illustrating a relation between the relative luminance and the view angle characteristics for each mode of the organic EL panel according to the present invention.

FIG. 5 is a graph illustrating relative power characteristics for each mode of the organic EL panel according to the present invention.

FIG. 6 is a graph illustrating relative drive current characteristics for each mode of the organic EL panel according to the present invention.

FIGS. 7A, 7B, and 7C are schematic views illustrating the organic EL panel, the pixel structure, and the pixel arrangement of a first example.

FIG. 8 illustrates a pixel circuit of the first example.

FIG. 9 is an operation timing chart of the organic EL panel of the first example.

FIG. 10 is a schematic view illustrating an organic EL panel of a second example.

FIG. 11 illustrates a pixel circuit of the second example.

FIG. 12 illustrates an example of a unit for generating two data signals from a piece of image data.

FIGS. 13A and 13B are operation timing charts of the organic EL panel of the second example.

FIG. 14 illustrates a pixel circuit of a third example.

FIGS. 15A and 15B are operation timing charts of the organic EL panel of the third example.

FIG. 16 illustrates a pixel circuit of a fourth example.

FIGS. 17A and 17B are operation timing charts of the organic EL panel of the fourth example.

### DESCRIPTION OF THE EMBODIMENTS

Preferred embodiments of the present invention will now be described in detail in accordance with the accompanying drawings.

Now, preferred embodiments of an organic EL display apparatus according to the present invention will be described referring to the accompanying drawings.

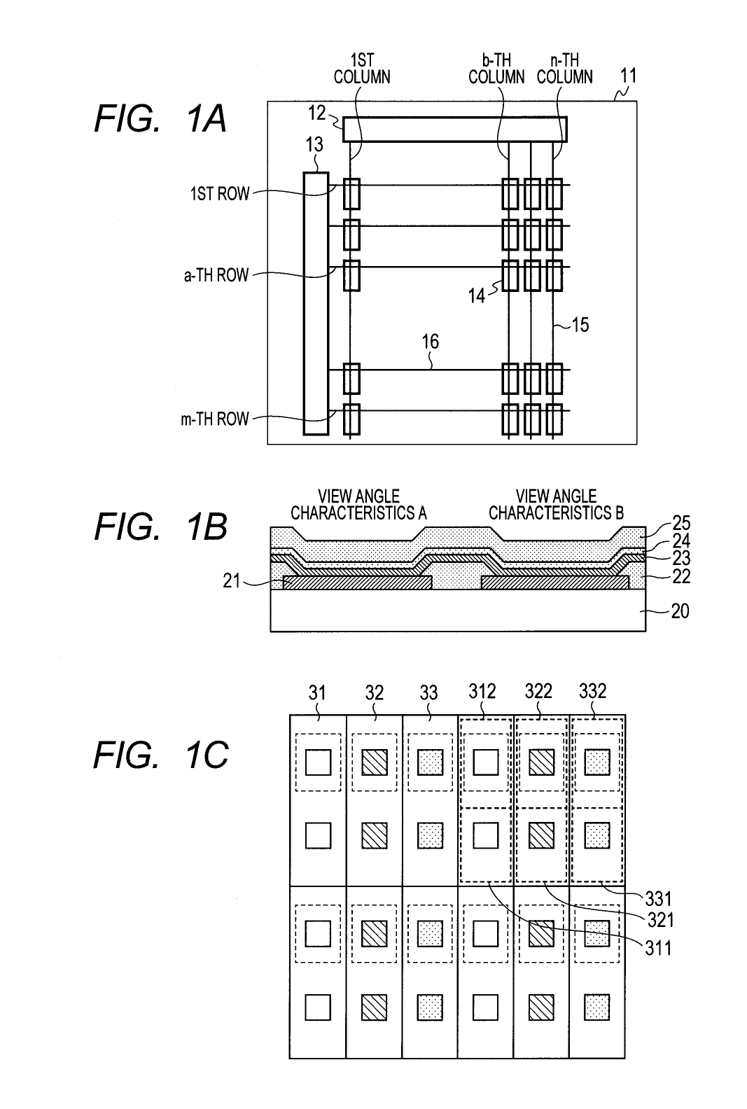

FIG. 1A is a schematic view illustrating an organic EL panel 11 having a plurality of pixels (m-row×n-column pixels) arranged in a matrix, in which an organic EL device is arranged for each pixel. FIG. 1A is an example of the organic EL panel according to the present invention. The organic EL panel 11 includes a data line drive circuit 12 for applying a data signal to a data line 15 and a gate line drive circuit 13 for driving a gate line 16. The organic EL panel 11 further includes a pixel circuit 14 being arranged for each pixel, having a plurality of transistors, and supplying a drive current to the organic EL device in response to the data signal to turn on the organic EL device. Each m-row n-column pixel is arranged at an intersection of each data line and each gate line. The pixel circuit 14 performs display based on a data signal corresponding to each pixel.

The data line drive circuit 12 is a data line driver for supplying a data signal corresponding to the image data to each pixel, and a circuit which receives image data from outside and controls a current flow for driving the organic EL device corresponding to the image data. The gate line drive circuit 13 is a gate line driver for driving each transistor of the pixel circuit 14 (driving the gate line 16 connected to a gate terminal of each transistor) and generates a pulse signal when a write operation is performed on the line. The gate line drive circuit 13 generally includes a shift register and other logic circuits to perform a write operation sequentially from the first row and generates a logic signal to allow the pixel circuit 14 to perform a write operation. The pixel circuit 14 receives the data signal driven by the data line drive circuit 12 from the data line 15 and performs a write operation on the pixel in the write line specified by the gate line drive circuit 13.

FIG. 1B is a partial sectional view illustrating a portion corresponding to a pixel (for example, a-th row b-th column in FIG. 1A) of the display apparatus of the present invention. The pixel of the display apparatus of the present invention has a plurality of sub-pixels. Here, a “sub-pixel” indicates a region having one light emitting device. FIG. 1B illustrates a top emission type display apparatus which extracts light from an upper surface (from the upper direction) of an organic EL device formed on a substrate, but the present invention can be applied to a bottom emission type display apparatus.

According to the present invention, an organic EL device as a light emitting device is formed for each of the plurality of sub-pixels, and the plurality of sub-pixels contained in the same pixel is different from each other in view angle characteristics (view angle characteristics A and view angle characteristics B). Specifically, each pixel has two sub-pixels emitting light of the same color, and a light condensing element is arranged on a light emitting surface side of the organic EL device having one sub-pixel of the two sub-pixels. Further, each pixel has three or more organic EL device groups, each organic EL device being arranged for each of the two sub-pixels and each organic EL device group consisting of two organic EL devices emitting light of the same color; and emits light of three or more colors. The two organic EL devices constituting an organic EL device group are a first organic EL device (hereinafter referred to as an organic EL device B) having a light condensing element arranged on the light emitting surface side and a second organic EL device (hereinafter referred to as an organic EL device A) not having a light condensing element arranged on the light emitting surface side. Preferably, a micro lens or the like is used as the light condensing element. Alternatively, the distance between a pair of electrodes may be changed such that one of the organic EL devices A and B has a synergic interference effect in the front direction and the other one has a synergic interference effect in an oblique direction (other than front direction).

A region separation layer 22 for separating between regions is provided between each organic EL device in a different region. Each organic EL device includes a pair of an anode electrode 21 and a cathode electrode 24 and an organic compound layer 23 (hereinafter referred to as an “organic EL layer”) being sandwiched between the electrodes and containing a luminescent layer. Specifically, a substrate 20 has thereon an anode electrode patterned for each organic EL device. The anode electrode 21 has thereon an organic EL layer 23. Further, the organic EL layer 23 has thereon a cathode electrode 24.

The anode electrode 21 is made of a conductive metal material having a high reflectance such as Ag. Alternatively, the anode electrode 21 may be made of a laminate between a layer made of such a metal material and a layer made of a transparent conductive material such as ITO (Indium-Tin-Oxide) excellent in hole injection characteristics.

The cathode electrode 24 is formed commonly to a plurality of organic EL devices and has a semi-reflective or light transmitting structure allowing light emitted by a luminescent layer to be extracted outside the device. Specifically, in a case in which the cathode electrode 24 is configured as a semi-reflective structure in order to improve the interference effect inside the device, the cathode electrode 24 is formed by forming a layer made of a conductive metal material such as Ag and AgMg having excellent electron injection characteristics with a film thickness of 2 to 50 nm. Note that the “non-reflectivity” means a property that a part of light generated inside the device is reflected and a part thereof is transmitted and has a reflectance of 20 to 80% with respect to visible light. The “optical transmission” refers to a property having a transmittance of 80% or more with respect to visible light.

The organic EL layer 23 is made of a single layer including at least a luminescent layer or a plurality of layers. Example configurations of the organic EL layer 23 include a 4-layer configuration including a hole transport layer, a luminescent layer, an electron transport layer, and an electron injection layer; a 3-layer configuration including a hole transport layer, a luminescent layer, and an electron transport layer; and the like. The organic EL layer 23 may be made of well-known materials.

The substrate 20 has a pixel circuit formed so as to be able to independently drive each organic EL device. Each pixel circuit includes a plurality of thin-film transistors (hereinafter referred to as TFTs (Thin-Film-Transistors)) (unillustrated). The substrate 20 including the TFTs is covered with an interlayer insulating film (unillustrated) having a contact hole for electrically connecting the TFTs and the anode electrode 21. The interlayer insulating film has thereon a planarization film (unillustrated) for planarizing the surface by absorbing the surface asperities due to the pixel circuit.

The cathode electrode 24 has thereon a protection layer 25 formed to protect the organic EL layer 23 from oxygen and moisture in the air. The protection layer 25 is made of an inorganic material such as SiN and SiON. Alternatively, the protection layer 25 is made of a film laminated between an inorganic material and an organic material. The film thickness of the inorganic film is preferably 0.1 μm or more and 10 μm or less. The inorganic film is preferably made by a CVD process. The organic film is used to improve the protection capability by covering foreign matters that adhere to the surface in the process and cannot be removed therefrom and hence the film thickness of the organic film is preferably 1 μm or more. Note that in FIG. 1B, the protection layer 25 is formed along the shape of the pixel separation layer 22, but the surface of the protection layer 25 may be flat. The use of an organic material allows the surface to be easily planarized.

The display apparatus of the present invention may be configured as an organic EL panel having three different hues or may be configured as an organic EL panel having four different hues without being limited to the three hues. In the case of a 3-hue configuration, the display apparatus may be an organic EL panel having three hues: R, G, and B and may be configured as an organic EL device having three hues: R, G, and B; or may be configured as a white organic EL device overlapped with color filters of three hues: R, G, and B. In this case, the display unit is a pixel unit including a pixel for displaying each hue of R, G, and B. In the case of a 4-hue configuration, the display apparatus may be, for example, an organic EL panel having four hues: R, G, B, and W.

FIG. 1C illustrates an example of a pixel arrangement of the organic EL panel of the present invention. The organic EL panel includes an R pixel 31, a G pixel 32, and a B pixel 33. The three pixels: the R pixel 31, the G pixel 32, and the B pixel 33 constitute a pixel unit of the organic EL panel. The R pixel 31 includes an R-1 sub-pixel 311 and an R-2 sub-pixel 312. Each sub-pixel commonly has a hue of R and has mutually different optical characteristics. The G pixel 32 includes a G-1 sub-pixel 321 and a G-2 sub-pixel 322. Each sub-pixel commonly has a hue of G and has mutually different optical characteristics. The B pixel 33 includes a B-1 sub-pixel 331 and a B-2 sub-pixel 332. Each sub-pixel commonly has a hue of B and has mutually different optical characteristics. Each pixel includes two sub-pixels having a hue of R and mutually different optical characteristics; two sub-pixels having a hue of G and mutually different optical characteristics; and two sub-pixels having a hue of B and mutually different optical characteristics.

The following description will be given assuming that the R-1 sub-pixel 311, the G-1 sub-pixel 321, and the B-1 sub-pixel 331 are made of a sub-pixel A having wide view-angle characteristics; and the R-2 sub-pixel 312, the G-2 sub-pixel 322, and the B-2 sub-pixel 332 are made of a sub-pixel B having high front side luminance characteristics. Here, the high front side luminance characteristics refer to high light extraction efficiency in the front direction, namely, in the normal direction of the substrate.

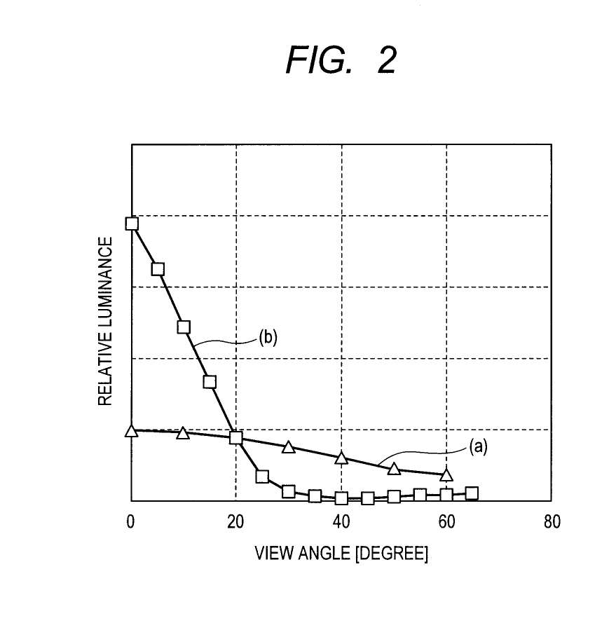

FIG. 2 is a graph illustrating a relation between the relative luminance and the view angle characteristics of each of the sub-pixels A and B, in which (a) in the figure illustrates a relation between the relative luminance and the view angle characteristics of the sub-pixel A; and (b) illustrates a relation between the relative luminance and the view angle characteristics of the sub-pixel B. The luminance is represented by relative luminance values obtained when the same current is injected to the sub-pixels A and B and the front side luminance of the sub-pixel A is assumed to be 1. From FIG. 2, the sub-pixel A has a wide view angle, and the sub-pixel B has a narrow view angle, but the front side luminance of the sub-pixel B is about four times that of the sub-pixel A.

Now, the operation of the organic EL panel 11 will be described. The two sub-pixels of each pixel of R, G, and B having different optical characteristics are independently driven by a pixel circuit capable of selectively turning on and off (emitting light and not emitting light). For example, the R-1 sub-pixel and the R-2 sub-pixel of the R pixel can be independently turned on and off.

When the sub-pixels are turned on by varying the luminance ratio (light emission ratio) of the R-1 sub-pixel 311, the G-1 sub-pixel 321, and the B-1 sub-pixel 331; and the luminance ratio of the R-2 sub-pixel 312, the G-2 sub-pixel 322, and the B-2 sub-pixel 332, a desired white balance can be obtained and high image quality can be provided. Since chromaticity is different in the front direction depending on whether a light condensing element such as a micro lens is present or not, the desired white balance can be obtained by turning on in a manner as described above. In order to display in the same hue by the organic EL elements A and B, the present invention provides each pixel with a luminance difference forming unit for varying the luminance ratio of each color in the organic EL device A and the luminance ratio of each color in the organic EL device B.

Further, it is more preferable to drive in the following three modes because display according to the user scene is enabled and high image quality can be provided.

When only the R-1 sub-pixel 311, the G-1 sub-pixel 321, and the B-1 sub-pixel 331 having wide view-angle optical characteristics are turned on, the organic EL panel 11 can obtain a wide view angle performance (hereinafter referred to as a “wide view angle mode”).

When only the R-2 sub-pixel 312, the G-2 sub-pixel 322, and the B-2 sub-pixel 332 having narrow view angle but having high front side luminance optical characteristics are turned on, the organic EL panel 11 can obtain high front side luminance performance (hereinafter referred to as an “outdoor visibility mode”).

When the R-2 sub-pixel 312, the G-2 sub-pixel 322, and the B-2 sub-pixel 332 are turned on at a low current and the front side luminance is set to the same luminance as when the R-1 sub-pixel 311, the G-1 sub-pixel 321, and the B-1 sub-pixel 331 are turned on, power consumption can be reduced (hereinafter referred to as a “power save mode”).

Further, it is more preferable to turn on the sub-pixels A and B in an intermediate state between the “wide view angle mode” and the “outdoor visibility mode” and in an intermediate state between the “wide view angle mode” and the “power save mode” because more various display according to the user scene is enabled and high image quality can be provided.

Thus, it is more preferable to have a unit for varying one or both of the on-time and the drive current in the same color organic EL devices A and B because the above effects can be obtained.

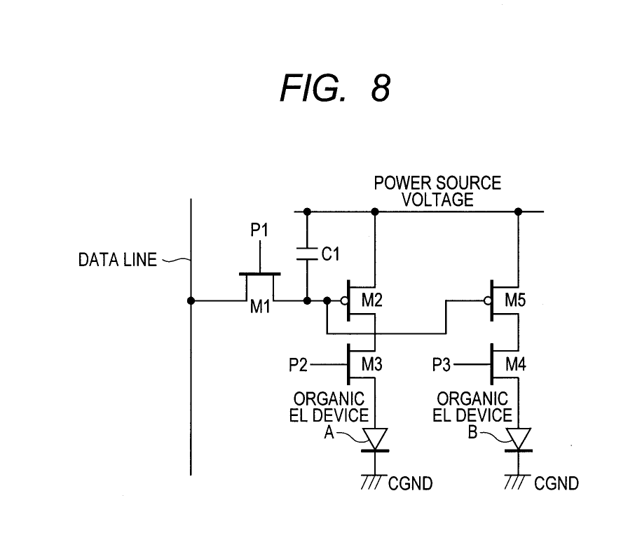

For example, the pixel circuits illustrated in FIGS. 8, 11, and 14 are suitable for the pixel circuit for driving in the above three modes. In any one of the above three modes, the two sub-pixels having the same color but having different optical characteristics are driven by common image data. The on-time and the drive current of each sub-pixel are changed according to the optical characteristics based on the relative characteristics between the front side luminance and the peripheral luminance and the above three modes.

Hereinafter, specific embodiments will be described in detail, but the present invention is not limited to the following four embodiments.

### First Embodiment

The display apparatus of the present embodiment includes an organic EL panel in FIG. 1A, a pixel structure in FIG. 1B, and a pixel arrangement in FIG. 1C. The R-1 sub-pixel 311, the G-1 sub-pixel 321, and the B-1 sub-pixel 331 in FIG. 1C are made of a sub-pixel A having wide view-angle characteristics. The R-2 sub-pixel 312, the G-2 sub-pixel 322, and the B-2 sub-pixel 332 in FIG. 1C are made of a sub-pixel B having high front side luminance (light extraction efficiency in the front direction) characteristics. For example, preferably, the surface of the sub-pixel containing the organic EL device A is a flat surface and a light condensing element such as a micro lens is formed in the sub-pixel containing the organic EL device B. FIG. 2 illustrates a relation between the relative luminance and the view angle characteristics of the sub-pixel containing the organic EL device A and the sub-pixel containing the organic EL device B. For example, the pixel circuit in FIG. 8 is suitable for the pixel circuit.

In order to display in the same hue by the organic EL elements A and B, the present embodiment varies the luminance ratio of each color in the organic EL device A and the luminance ratio of each color in the organic EL device B. Specifically, the same data signal is written to the organic EL devices A and B of the same color from the data line 15 in FIG. 1A to vary the luminance ratio of each color in the organic EL devices A and B in each pixel circuit. As the luminance difference forming unit for varying the luminance ratio of each color in the organic EL devices A and B in each pixel circuit, for example, a TFT (M2) and a TFT (M5) having a mutually different transistor size (W/L ratio) in FIG. 8 are used. In this case, the current drive capability differs between the organic EL devices A and B.

Here, the current drive capability of TFT (M2) of the R pixel is assumed to be DR1; the current drive capability of TFT (M2) of the G pixel is assumed to be DG1; and the current drive capability of TFT (M2) of the B pixel is assumed to be DB1. Further, the current drive capability of TFT (M5) of the R pixel is assumed to be DR2; the current drive capability of TFT (M5) of the G pixel is assumed to be DG2; and the current drive capability of TFT (M5) of the B pixel is assumed to be DB2. In FIG. 8, the current drive capability ratio of DR1:DG1:DB1 is made different from that of DR2:DG2:DB2. DR1:DG1:DB1 is made different from DR2:DG2:DB2, which varies the drive current between the organic EL devices A and B, thereby enabling adjustment of white balance. More specifically, even if the same voltage data Vdata as a data signal is input to the R pixel, the G pixel, and the B pixel, the luminance balance of the R pixel, the G pixel, and the B pixel can be changed according to the current drive capability ratio, thereby enabling adjustment to a desired white balance.

In a case in which the organic EL elements A and display in the same hue, the drive current ratio required for the R pixel, the G pixel, and the B pixel is assumed to be IR1:IG1:IB1 for the organic EL device A and IR2:IG2:IB2 for the organic EL device B. In this case, the drive current ratio may be set to DR1:DG1:DB1=IR1:IG1:IB1 or DR2:DG2:DB2=IR2:IG2:IB2. At this time, the luminance is LR1:LG1:LB1≠LR2:LG2:LB2. LR1 denotes a luminance of the organic EL device A in the R pixel; LG1 denotes a luminance of the organic EL device A in the G pixel, and LB1 denotes a luminance of the organic EL device A in the B pixel. LR2 denotes a luminance of the organic EL device B in the R pixel; LG2 denotes a luminance of the organic EL device B in the G pixel, and LB2 denotes a luminance of the organic EL device B in the B pixel. Specifically, the luminance ratio of each color in the organic EL devices A and B is made different so as to satisfy LR1:LG1:LB1≠LR2:LG2:LB2.

Thus, the present embodiment can vary the luminance ratio of each color in the organic EL devices A and B, thereby allowing white balance to be adjusted and high image quality to be provided.

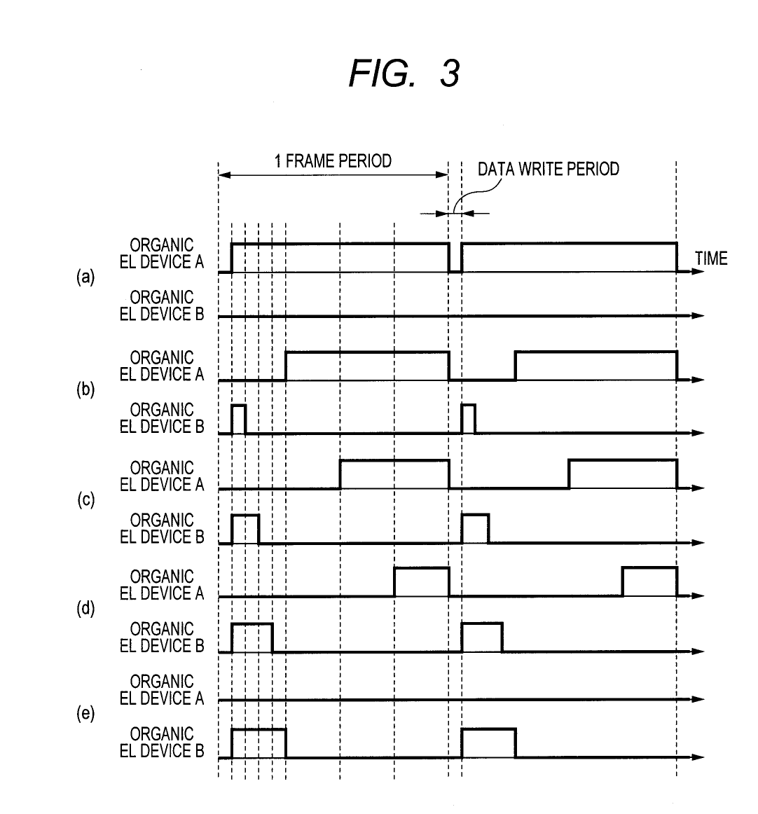

Further, in the present embodiment, it is more preferable to vary the on-time of the organic EL devices A and B of the same color because display according to the user scene is enabled and high image quality can be provided. Specifically, the same data signal is written to the organic EL devices A and B of the same color through the data line 15 in FIG. 1A to vary the on-time of the organic EL devices A and B of the same color in each pixel circuit. A lighting period difference forming unit for varying the on-time of the organic EL devices A and B of the same color in each pixel circuit is preferably connected separately to each of the organic EL devices A and B of the same color to individually turn on and off each of the organic EL devices A and B of the same color. Examples of the unit are P2 and TFT (M3), and P3 and TFT (M4) in FIGS. 8. M3 and M4 are switches provided on a path for supplying a drive current to the organic EL devices A and B respectively to control the drive current flow. M3 and M4 are controlled to be turned on and off separately by selection control lines P2 and P3 respectively. Hereinafter, the more preferable embodiment will be described referring to FIG. 3.

FIG. 3 is an operation timing chart for each mode of the organic EL panel according to the present embodiment. In FIG. 3, the horizontal axis indicates time and the vertical axis indicates ON (HI) and OFF (LOW) thereof. Assuming that the front side luminance ratio is sub-pixel (a): sub-pixel (b)=1:4, where the sub-pixel(a) contains the organic EL device A and the sub-pixel(b) contains the organic EL device B as illustrated in FIG. 2, the relation between the peripheral luminance and power is included in setting conditions. The setting conditions are as follows.

First, the description will focus on a case in which the “wide view angle mode” and “power save mode” can be selected. In order to enable the two modes, the front side luminance of the sub-pixel containing the organic EL device A is made to match that of the sub-pixel containing the organic EL device B. Here, in FIG. 3, the power ratio of each mode per frame is assumed to include five modes: (a):(b):(c):(d):(e)=16:13:10:7:4. In this case, (a) indicates (on-time of the organic EL device A): (on-time of the organic EL device B)=16:0, (b) indicates 12:1, (c) indicates 8:2, (d) indicates 4:3, and (e) indicates 0:4. Note that the current-time product ratio of the organic EL device A and the organic EL device B per frame is such that (a) is 4:0, (b) is 3:1, (c) is 2:2, (d) is 1:3, and (e) is 0:4. The drive current applied from a pixel circuit is always the same current in any on timing.

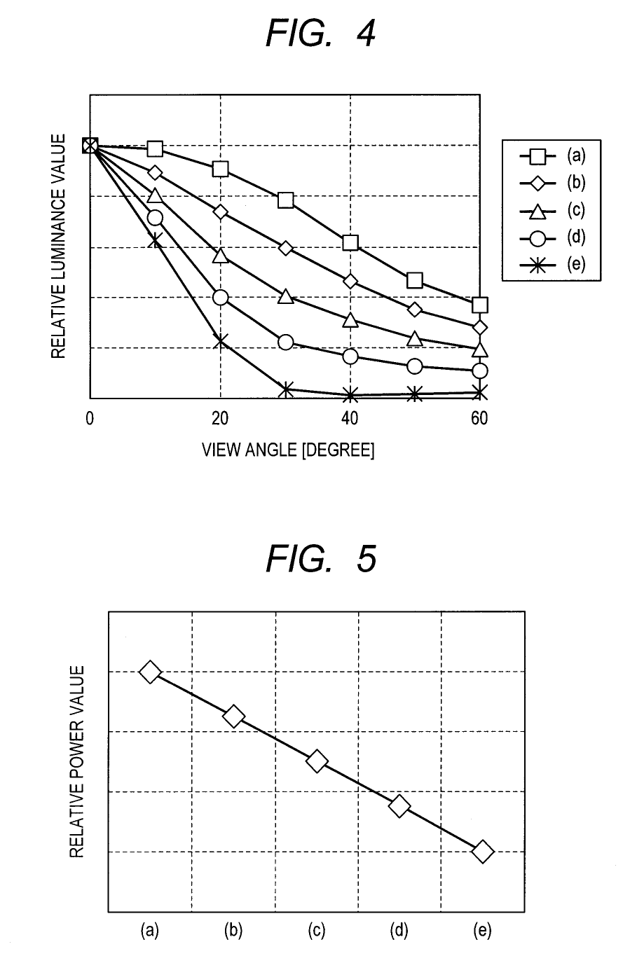

FIG. 4 is a graph illustrating a relation between the relative luminance and the view angle characteristics when the device is turned on in this manner; and FIG. 5 is a graph illustrating relative power characteristics thereof. The modes (a) to (e) in FIG. 4 and (a) to (e) in FIG. 5 correspond to (a) to (e) in FIG. 3. It is understood from FIG. 4 that the view angle is widened as a transition from (e) to (a). It is understood from FIG. 5 that the power consumption can be suppressed as a transition from (a) to (e). Thus, when organic EL devices are turned on like (a), the “wide view angle mode” can be selected and when the organic EL devices are turned on like (e), the “power save mode” can be selected. Further, when the organic EL devices are turned on like (b) to (d), an intermediate state between the “wide view angle mode” and the “power save mode” can also be selected. Thus, high image quality can be provided.

Next, the description will focus on a case in which the “wide view angle mode” and the “outdoor visibility mode” can be selected. In order to enable the two modes, the front side luminance of the sub-pixel containing the organic EL device A is not made to match that of the sub-pixel containing the organic EL device B. Here, the power ratio of each mode per frame is assumed to include five modes: (a):(b):(c):(d):(e)=4:7:10:13:16. In this case, (a) indicates (on-time of the organic EL device A): (on-time of the organic EL device B)=4:0, likewise, (b) indicates 3:4, (c) indicates 2:8, (d) indicates 1:12, and (e) indicates 0:16. Note that the current-time product ratio of the organic EL device A and the organic EL device B per frame is 4:0 in (a), 3:1 in (b), 2:2 in (c), 1:3 in (d), and 0:4 in (e).

When the device is turned on in this manner, the view angle is widened as a transition from (e) to (a), and the front side luminance is increased as a transition from (a) to (e). Thus, when organic EL devices are turned on like (a), the “wide view angle mode” can be selected and when the organic EL devices are turned on like (e), the “outdoor visibility mode” can be selected. Further, when the organic EL devices are turned on like (b) to (d), an intermediate state between the “wide view angle mode” and the “outdoor visibility mode” can also be selected. Thus, high image quality can be provided.

The present embodiment allows the number of writes to the organic EL devices A and B of the same color from the same data line to be one, and thus can increase the layout efficiency by simplifying the peripheral circuits, sharing wirings, and the like. Further, the present embodiment can maintain the signal level of the data line 15 for the organic EL devices A and B of the same color in substantially the same dynamic range and thus can increase the S/N ratio.

### Second Embodiment

The display apparatus of the present embodiment is the same as the first embodiment except that the pixel circuit is different. For example, the pixel circuit in FIG. 11 is suitable for the pixel circuit.

In order to display in the same hue by the organic EL elements A and B, the present embodiment varies the luminance ratio of each color in the organic EL device A and the luminance ratio of each color in the organic EL device B. Specifically, the data line drive circuit 12 in FIG. 1A generates a data signal for each of the organic EL devices A and B of the same color and writes a different signal to the data line 15 to vary the luminance ratio of each color in the organic EL devices A and B. As the luminance difference forming unit for varying the luminance ratio of each color in the organic EL devices A and B in the data line drive circuit 12 (data line driver), a unit is preferable in which a different data signal is generated and supplied to each gate terminal of a drive transistor provided for each of the organic EL devices A and B of the same color. In this case, each pixel circuit preferably has therein a unit for maintaining a data signal corresponding to each of the organic EL devices A and B. The use of different data signals can vary the drive current in each of the organic EL devices A and B, thereby allowing white balance to be adjusted. The operation timing chart of the organic EL panel will be described in the second example.

The current drive capability ratio of the organic EL devices A and B is the same as described in the first embodiment. In order to display in the same hue by the organic EL elements A and B, a data signal corresponding to each organic EL device A in the R pixel, the G pixel, and the B pixel is made different from a data signal corresponding to each organic EL device B in the R pixel, the G pixel and the B pixel. The drive current ratio required for the R pixel, the G pixel, and the B pixel is assumed to be IR1:IG1:IB1 for the organic EL device A and IR2:IG2:IB2 for the organic EL device B. In this case, the drive current ratio may be set such that IR1/IR2≠IG1/IG2≠IB1/IB2. At this time, the luminance is such that LR1/LR2≠LG1/LG2≠LB1/LB2. LR1 denotes a luminance of the organic EL device A in the R pixel; LG1 denotes a luminance of the organic EL device A in the G pixel, and LB1 denotes a luminance of the organic EL device A in the B pixel. LR2 denotes a luminance of the organic EL device B in the R pixel; LG2 denotes a luminance of the organic EL device B in the G pixel, and LB2 denotes a luminance of the organic EL device B in the B pixel. Specifically, the luminance ratio of each color in the organic EL devices A and B is made different so as to satisfy LR1/LR2≠LG1/LG2≠LB1/LB2.

Thus, the present embodiment can vary the luminance ratio of each color in the organic EL devices A and B, thereby allowing white balance to be adjusted and the organic EL elements A and B display in the same hue, to provide high image quality.

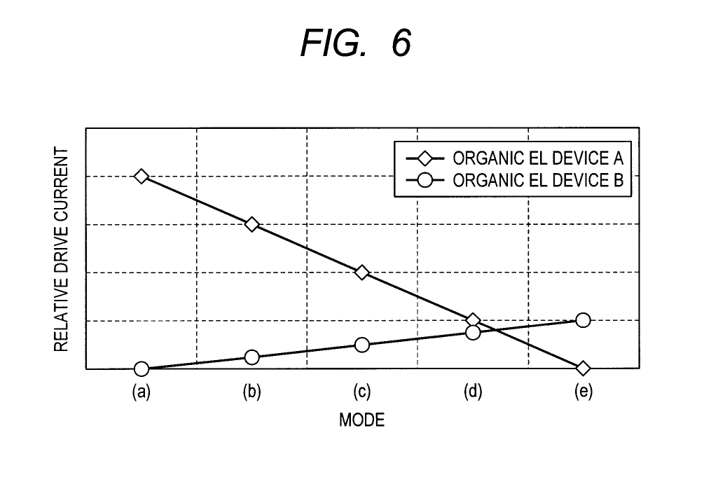

Further, in the present embodiment, it is more preferable to set the same on-time of the organic EL devices A and B of the same color and to vary the drive current thereof because display according to the user scene is enabled and high image quality can be provided. Specifically, each data signal is generated by the data line drive circuit 12 in FIG. 1A for the organic EL devices A and B of the same color and each different data signal is written to the data line 15 to vary the drive current to be supplied to the organic EL devices A and B of the same color in each pixel circuit. For example, each different data signal is generated and supplied to each gate terminal of a drive transistor provided for each of the organic EL devices A and B of the same color. Hereinafter, the more preferable embodiment will be described referring to FIG. 6.

FIG. 6 is a graph illustrating relative drive current characteristics for each mode of the organic EL panel according to the present embodiment. In FIG. 6, the horizontal axis indicates each mode and the vertical axis indicates the relative drive current of the organic EL devices A and B. Assuming that the front side luminance ratio is such that sub-pixel (a): sub-pixel (b)=1:4, where the sub-pixel(a) contains the organic EL device A and the sub-pixel(b) contains the organic EL device B as illustrated in FIG. 2, the relation between the peripheral luminance and power is included in setting conditions. The setting conditions are as follows.

First, the description will focus on a case in which the “wide view angle mode” and “power save mode” can be selected. In order to enable the two modes, as described above, the front side luminance of the sub-pixel containing the organic EL device A is made to match that of the sub-pixel containing the organic EL device B. Here, in FIG. 6, the power ratio of each mode per frame is assumed to include five modes: (a):(b):(c):(d):(e)=16:13:10:7:4. In this case, (a) indicates (drive current of the organic EL device A): (drive current of the organic EL device B)=16:0, (b) indicates 12:1, (c) indicates 8:2, (d) indicates 4:3, and (e) indicates 0:4. Note that the current-time product ratio of the organic EL device A and the organic EL device B per frame is 4:0 in (a), 3:1 in (b), 2:2 in (c), 1:3 in (d), and 0:4 in (e).

FIG. 4 is a graph illustrating a relation between the relative luminance and the view angle characteristics when the device is turned on in this manner; and FIG. 5 is a graph illustrating relative power characteristics thereof. The modes (a) to (e) in FIG. 4 and (a) to (e) in FIG. 5 correspond to (a) to (e) in FIG. 6. Thus, like the first embodiment, the view angle is widened as a transition from (e) to (a), and the power consumption can be suppressed as a transition from (a) to (e). Accordingly, like the first embodiment, the “wide view angle mode” and “power save mode” can be selected, and an intermediate state between the “wide view angle mode” and the “power save mode” can also be selected. Thus, high image quality can be provided.

Next, the description will focus on a case in which the “wide view angle mode” and the “outdoor visibility mode” can be selected. In order to enable the two modes, as described above, the front side luminance of the sub-pixel containing the organic EL device A is not made to match that of the sub-pixel containing the organic EL device B. Here, the power ratio of each mode per frame is assumed to include five modes: (a):(b):(c):(d):(e)=4:7:10:13:16. In this case, (a) indicates (drive current of the organic EL device A): (drive current of the organic EL device B)=4:0, likewise, (b) indicates 3:4, (c) indicates 2:8, (d) indicates 1:12, and (e) indicates 0:16. Note that the current-time product ratio of the organic EL device A and the organic EL device B per frame is 4:0 in (a), 3:1 in (b), 2:2 in (c), 1:3 in (d), and 0:4 in (e).

When the device is turned on in this manner, like the first embodiment, the view angle is widened as a transition from (e) to (a), and the front side luminance is increased as a transition from (a) to (e). Accordingly, like the first embodiment, the “wide view angle mode” and “outdoor visibility mode” can be selected, and an intermediate state between the “wide view angle mode” and the “outdoor visibility mode” can also be selected. Thus, high image quality can be provided.

Further, the present embodiment allows detailed drive conditions to be set for each mode by the data line drive circuit 12, thus enabling high-usability drive. Further, the present embodiment enables easy correction of gamma characteristics and the like for the organic EL devices A and B of the same color, thus enabling high quality drive.

### Third Embodiment

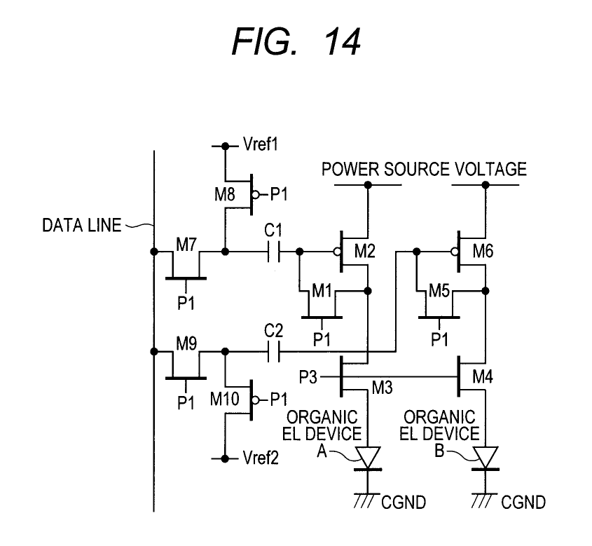

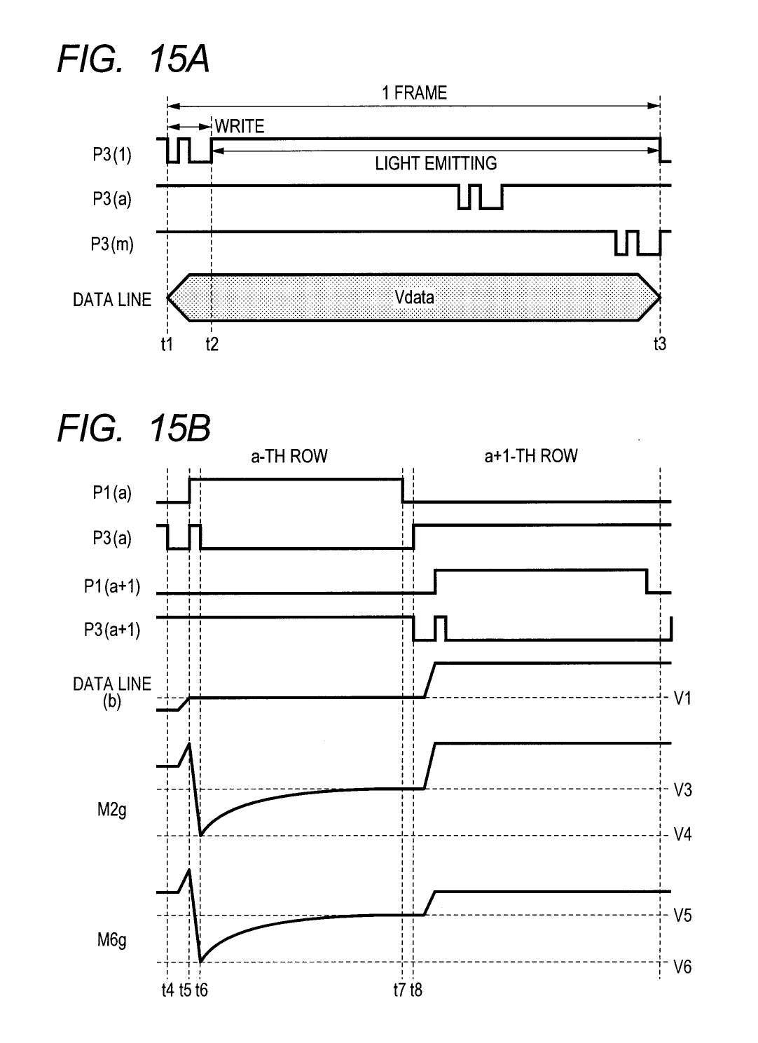

The display apparatus of the present embodiment is the same as the second embodiment except that the pixel circuit is different. For example, the pixel circuit in FIG. 14 is suitable for the pixel circuit.

In order to display in the same hue by the organic EL elements A and B, the present embodiment varies the luminance ratio of each color in the organic EL device A and the luminance ratio of each color in the organic EL device B. Specifically, the same data signal is written to the organic EL devices A and B of the same color from the data line 15 in FIG. 1A to vary the luminance ratio of each color in the organic EL devices A and B in each pixel circuit. As the luminance difference forming unit for varying the luminance ratio of each color in the organic EL devices A and B in each pixel circuit, a unit is preferable in which different voltage (reference voltage) is supplied to each gate terminal of a drive transistor provided for each of the organic EL devices A and B of the same color. An example of the unit is illustrated in FIG. 14, in which voltages Vref1 and Vref2 are applied to the gate terminal of TFT (M2) and the gate terminal of TFT (M6) as the drive TFTs respectively. The use of different voltages can vary the drive current in each of the organic EL devices A and B, thereby allowing white balance to be adjusted. The current drive capability ratio, the drive current ratio, and the luminance of the organic EL devices A and B are the same as described in the second embodiment. The operation timing chart of the organic EL panel will be described in the third example.

Thus, the present embodiment can vary the luminance ratio of each color in the organic EL devices A and B, thereby allowing white balance to be adjusted and the organic EL elements A and B display in the same hue to provide high image quality.

Further, in the present embodiment, it is more preferable to set the same on-time of the organic EL devices A and B of the same color and to vary the drive current thereof because display according to the user scene is enabled and high image quality can be provided. Specifically, the same data signal is written to the organic EL devices A and B of the same color from the data line 15 in FIG. 1A to vary the drive current to be supplied to the organic EL devices A and B of the same color in each pixel circuit. For example, a different voltage (reference voltage) can be supplied to each gate terminal of a drive transistor provided for each of the organic EL devices A and B of the same color. Hereinafter, the more preferable embodiment will be described.

FIG. 6 is a graph illustrating relative drive current characteristics for each mode of the organic EL panel according to the present embodiment. Assuming that the front side luminance ratio is such that sub-pixel (a): sub-pixel (b)=1:4, where the sub-pixel(a) contains the organic EL device A and the sub-pixel(b) contains the organic EL device B as illustrated in FIG. 2, the relation between the peripheral luminance and power is included in setting conditions. The setting conditions are as follows.

First, the description will focus on a case in which the “wide view angle mode” and “power save mode” can be selected. Like the second embodiment, the power ratio of each mode per frame is assumed to include five modes: (a):(b):(c):(d):(e)=16:13:10:7:4. In this case, the drive current ratio of the organic EL devices A and B is 16:0 in (a), 12:1 in (b), 8:2 in (c), 4:3 in (d), and 0:4 in (e). Note that the current-time product ratio of the organic EL device A and the organic EL device B per frame is 4:0 in (a), 3:1 in (b), 2:2 in (c), 1:3 in (d), and 0:4 in (e).

When the device is turned on in this manner, like the second embodiment, the view angle is widened as a transition from (e) to (a), and the power consumption can be suppressed as a transition from (a) to (e). Accordingly, like the second embodiment, the “wide view angle mode” and “power save mode” can be selected, and an intermediate state between the “wide view angle mode” and the “power save mode” can also be selected. Thus, high image quality can be provided.

Next, the description will focus on the setting conditions of a case in which the “wide view angle mode” and the “outdoor visibility mode” can be selected. Like the second embodiment, the power ratio of each mode per frame is assumed to include five modes: (a):(b):(c):(d):(e)=4:7:10:13:16. In this case, the drive current ratio of the organic EL devices A and B is 4:0 in (a), 3:4 in (b), 2:8 in (c), 1:12 in (d), and 0:16 in (e). Note that the current-time product ratio of the organic EL device A and the organic EL device B per frame is 4:0 in (a), 3:1 in (b), 2:2 in (c), 1:3 in (d), and 0:4 in (e).

When the device is turned on in this manner, like the second embodiment, the view angle is widened as a transition from (e) to (a), and the front side luminance is increased as a transition from (a) to (e). Accordingly, like the second embodiment, the “wide view angle mode” and “outdoor visibility mode” can be selected, and an intermediate state between the “wide view angle mode” and the “outdoor visibility mode” can also be selected. Thus, high image quality can be provided.

Further, like the first embodiment, the present embodiment can increase not only the layout efficiency but also the S/N ratio by simplifying the peripheral circuits, sharing wirings, and the like.

### Fourth Embodiment

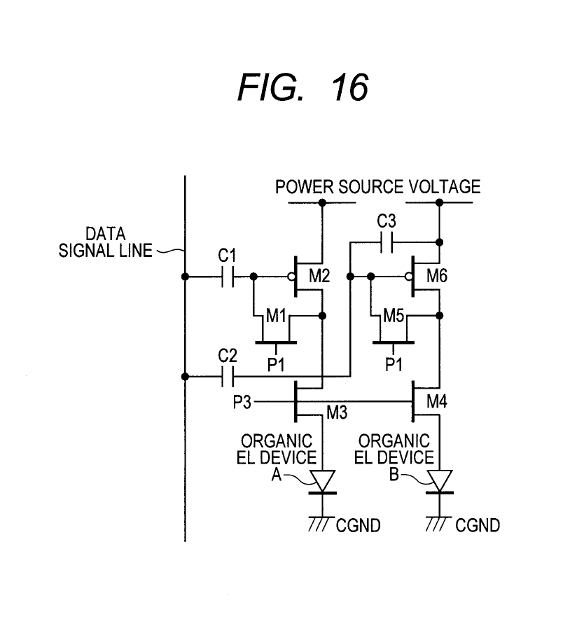

The display apparatus of the present embodiment is the same as the second embodiment except that the pixel circuit is different. For example, the pixel circuit in FIG. 16 is suitable for the pixel circuit.

In order to display in the same hue by the organic EL elements A and B, the present embodiment varies the luminance ratio of each color in the organic EL device A and the luminance ratio of each color in the organic EL device B. Specifically, the same data signal is written to the organic EL devices A and B of the same color from the data line 15 in FIG. 1A to vary the luminance ratio of each color in the organic EL devices A and B in each pixel circuit. As the luminance difference forming unit for varying the luminance ratio of each color in the organic EL devices A and B in each pixel circuit, a unit is preferable in which the voltage of a data signal to be written to the organic EL device B is reduced. An example of the unit is a capacitor C3 illustrated in FIG. 16. The use of a different reduced voltage of the data signal can vary the drive current in each of the organic EL devices A and B, thereby allowing white balance to be adjusted. The current drive capability ratio, the drive current ratio, and the luminance of the organic EL devices A and B are the same as described in the second embodiment. The operation timing chart of the organic EL panel will be described in the fourth example.

Thus, the present embodiment can vary the luminance ratio of each color in the organic EL devices A and B, thereby allowing white balance to be adjusted and high image quality to be provided.

The first to third embodiments have five steps from (a) to (e) for switching modes as illustrated in FIGS. 3 and 6, but the resolution may be increased or the modes may be steplessly changed between (a) and (e).

Hereinafter, the present invention will be described in detail by examples.

### First Example

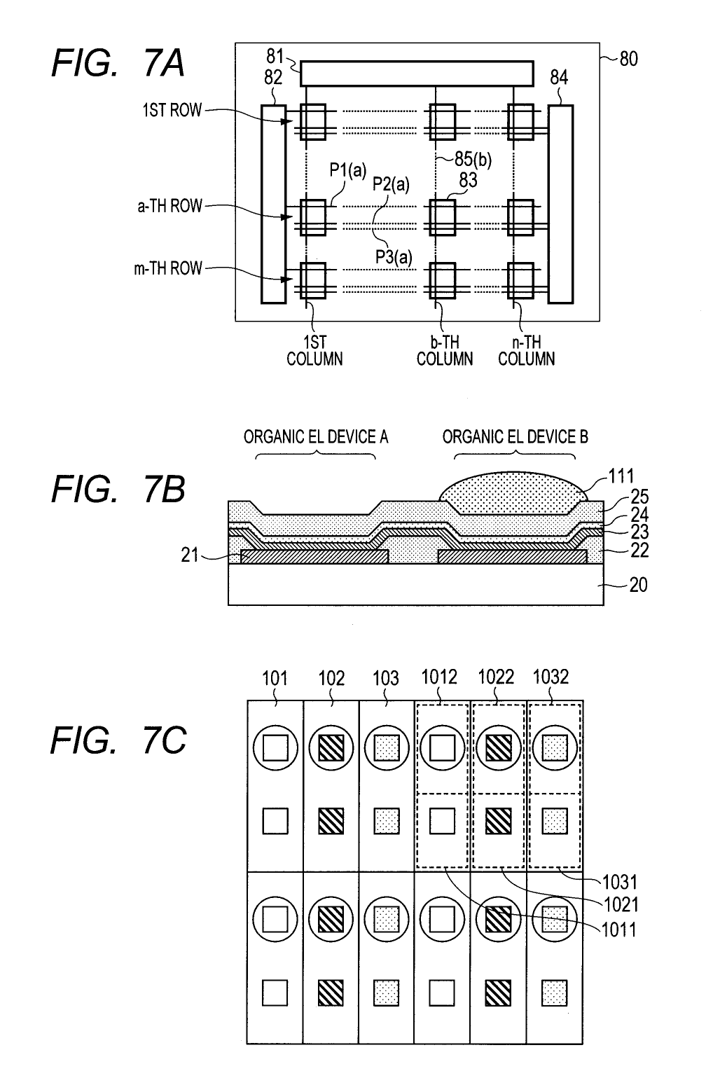

FIG. 7A is a schematic view illustrating an organic EL panel 80 having a plurality of pixels (m-row×n-column pixels) arranged in a matrix and having an organic EL device arranged for each pixel. The organic EL panel 80 is the organic EL panel of the present example. The organic EL panel 80 includes unillustrated organic EL devices, a data line drive circuit 81 (data line driver), a gate line drive circuit 82 (gate line driver), a pixel circuit 83, and a gate line drive circuit 84 (gate line driver). The data line drive circuit 81 applies a data signal to a data line 85. The gate line drive circuit 82 drives a gate line P1. The pixel circuit 83 is provided for each pixel, has a plurality of transistors, and supplies a drive current to an organic EL device according to the data signal to turn on the organic EL device. The gate line drive circuit 84 drives gate lines (selection control lines) P2 and P3 in a display region. Each pixel includes two sub-pixels emitting light of R and having different optical characteristics; two sub-pixels emitting light of G and having different optical characteristics; and two sub-pixels emitting light of B and having different optical characteristics. Each of the sub-pixels includes an organic EL device. In FIG. 7A, the gate line drive circuit 82 and the gate line drive circuit 84 in a display region are arranged left and right respectively with the pixel group sandwiched therebetween, but one of the circuits may be arranged on one side of left and right sides, or a circuit having the same function may be arranged left and right to be driven from both sides so as to improve the quality of write operation to the pixel.

FIG. 7B is a partial sectional view illustrating a portion corresponding to a pixel of the display apparatus of the present example. The layers under the protection layer 25 are the same as illustrated in FIG. 1B. The sub-pixel containing the organic EL device A has a flat surface and a micro lens 111 is formed on the surface of the sub-pixel containing the organic EL device B. The micro lens 111 is formed by processing a resin material and specifically can be formed by a method such as embossing.

In a case in which the sub-pixel does not have a micro lens, light emitted obliquely from a luminescent layer of the organic EL layer 23 is emitted further obliquely or fully reflected when emitted from the protection layer 25. Thus, the light cannot be extracted outside. In contrast to this, in a case in which the sub-pixel has the micro lens 111, light emitted from a luminescent layer of the organic EL layer 23 is transmitted through a transparent cathode electrode 24, the protection layer 25, and the micro lens 111 in this order, and then is emitted outside.

When the micro lens 111 is present, the emission angle is closer to the normal direction of the substrate than when a micro lens is not present. Accordingly, when the micro lens 111 is present, the light collection effect in the normal direction of the substrate is increased. Specifically, the display apparatus can increase the light use efficiency in the front direction. Further, when the micro lens 111 is present, the incident angle of the light emitted obliquely from the luminescent layer with respect to the emission interface is close to vertical, and hence the amount of fully reflected light is reduced. As a result, the light extraction efficiency is increased.

Thus, the organic EL panel 80 of the present example includes a sub-pixel having a flat surface on the light emitting surface side of the organic EL device; and a sub-pixel having a micro lens on the light emitting surface side of the organic EL device (on a side of extracting light, namely, an upper side of a top emission type organic EL device). The sub-pixel containing the organic EL device A has no micro lens and hence has wide view angle optical characteristics, and the sub-pixel containing the organic EL device B has a micro lens and hence has high front side luminance optical characteristics (light extraction efficiency in the front direction).

FIG. 7C illustrates a pixel arrangement of the organic EL panel of the present example. The organic EL panel includes an R pixel 101, a G pixel 102, and a B pixel 103. The three pixels of the R pixel 101, the G pixel 102, and the B pixel 103 constitute one pixel unit. The R pixel 101 has an R-1 sub-pixel 1011 and an R-2 sub-pixel 1012. The G pixel 102 has a G-1 sub-pixel 1021 and a G-2 sub-pixel 1022. The B pixel 103 has a B-1 sub-pixel 1031 and a B-2 sub-pixel 1032. Each of the R-1 sub-pixel 1011, the G-1 sub-pixel 1021, and the B-1 sub-pixel 1031 has a flat surface on the light emitting surface side. Each of the R-2 sub-pixel 1012, the G-2 sub-pixel 1022, and the B-2 sub-pixel 1032 has thereon a micro lens on the light emitting surface side of the organic EL device. The R-1 sub-pixel 1011, the G-1 sub-pixel 1021, and the B-1 sub-pixel 1031 have a relation between the relative luminance and the view angle characteristics as illustrated by (a) in FIG. 2; and the R-2 sub-pixel 1012, the G-2 sub-pixel 1022, and the B-2 sub-pixel 1032 have a relation between the relative luminance and the view angle characteristics as illustrated by (b) in FIG. 2.

FIG. 8 illustrates a pixel circuit of the present example. A gate line P1 is connected to a gate terminal of TFT (M1). A selection control line P2 of the organic EL device A is connected to a gate terminal of TFT (M3). A selection control line P3 of the organic EL device B is connected to a gate terminal of TFT (M4). The data line is connected to a drain terminal of TFT (M1), and voltage data Vdata as a data signal is input from the data line. The anode electrode of the organic EL device A is connected to the source terminal of TFT (M3), and the cathode electrode thereof is connected to a ground voltage CGND. The anode electrode of the organic EL device B is connected to the source terminal of TFT (M4), and the cathode electrode thereof is connected to a ground voltage CGND. The drain terminal of TFT (M3) is connected to the drain terminal of TFT (M2), and the source terminal of TFT (M2) is connected to a power source voltage. The drain terminal of TFT (M4) is connected to the drain terminal of TFT (M5), and the source terminal of TFT (M5) is connected to the power source voltage. The source terminal of TFT (M1) is connected to one end of the capacitor C1 and the gate terminal of TFT (M2). The other end of the capacitor C1 is connected to the power source voltage.

According to the present example, in order to display in the same hue by the organic EL elements A and B, the same data signal is written to the organic EL devices A and B of the same color from the data line 85 in FIG. 7A to vary the luminance ratio of each color in the organic EL devices A and B in each pixel circuit. As the luminance difference forming unit for varying the luminance ratio of each color in the organic EL devices A and B in each pixel circuit, for example, M2 and M5 having a mutually different transistor size (W/L ratio) in FIG. 8 are used. In this case, the current drive capability differs between the organic EL devices A and B.

Here, the current drive capability of TFT (M2) of the R pixel is assumed to be DR1; the current drive capability of TFT (M2) of the G pixel is assumed to be DG1; and the current drive capability of TFT (M2) of the B pixel is assumed to be DB1. Further, the current drive capability of TFT (M5) of the R pixel is assumed to be DR2; the current drive capability of TFT (M5) of the G pixel is assumed to be DG2; and the current drive capability of TFT (M5) of the B pixel is assumed to be DB2. In FIG. 8, the current drive capability ratio of DR1:DG1:DB1 is made different from that of DR2:DG2:DB2. DR1:DG1:DB1 is made different from DR2:DG2:DB2, which varies the drive current between the organic EL devices A and B, thereby enabling adjustment of white balance. More specifically, even if the same voltage data Vdata as a data signal is inputted to the R pixel, the G pixel, and the B pixel, the luminance balance of the R pixel, the G pixel, and the B pixel can be changed according to the current drive capability ratio, thereby enabling adjustment to a desired white balance.

When obtaining a desired white balance, the drive current ratio required for the R pixel, the G pixel, and the B pixel is assumed to be IR1:IG1:IB1 for the organic EL device A and IR2:IG2:IB2 for the organic EL device B. In this case, the drive current ratio may be set such that DR1:DG1:DB1=IR1:IG1:IB1 or DR2:DG2:DB2=IR2:IG2:IB2. At this time, the luminance is such that LR1:LG1:LB1≠LR2:LG2:LB2. LR1 denotes a luminance of the organic EL device A in the R pixel; LG1 denotes a luminance of the organic EL device A in the G pixel, and LB1 denotes a luminance of the organic EL device A in the B pixel. LR2 denotes a luminance of the organic EL device B in the R pixel; LG2 denotes a luminance of the organic EL device B in the G pixel, and LB2 denotes a luminance of the organic EL device B in the B pixel. Specifically, the luminance ratio of each color in the organic EL devices A and B is made different so as to satisfy LR1:LG1:LB1≠LR2:LG2:LB2.

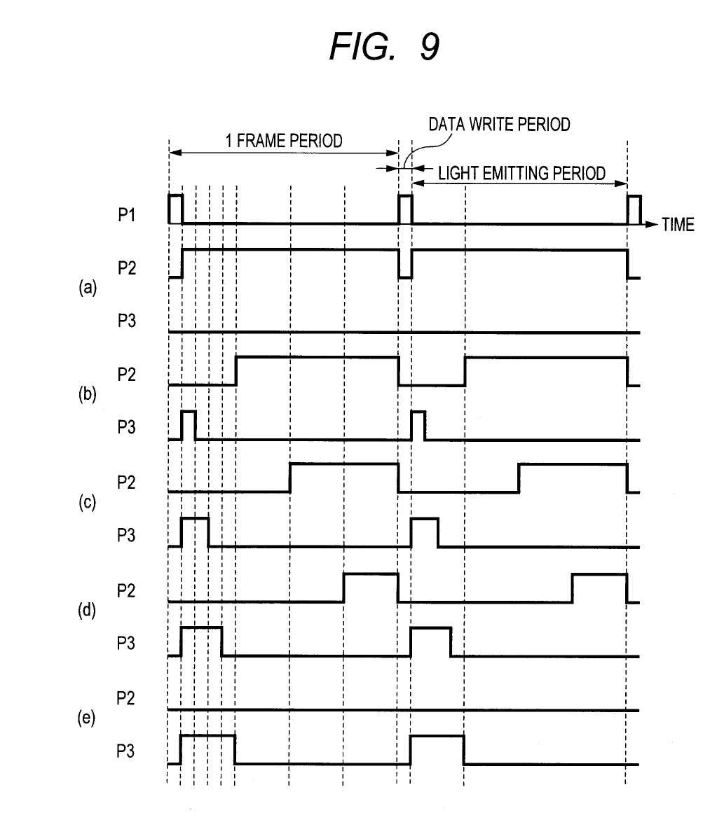

Next, the operation of the pixel circuit in FIG. 8 will be described using a timing chart in FIG. 9. In FIG. 9, the horizontal axis indicates time and the vertical axis indicates ON (HI) and OFF (LOW) of P1 to P3. P2 and P3 are signals responsible for light emission of the organic EL devices A and B.

The data write period in FIG. 9 will be described.

In this period, a HI-level signal is input to P1; a LOW-level signal is input to P2 and P3; and M1 is turned ON and M3 and M4 are turned OFF. At this time, M3 and M4 are not in a conducting state, and hence no current flows through the organic EL devices A and B. Vdata causes a voltage according to the current drive capability of M1 to occur in C1 interposed between the gate terminals of M2 and M5 and the power source voltage V1. Specifically, a data signal is written (Vdata is input). The above description assumes that M1, M3, and M4 are nMOS, and M2 is pMOS. If M1, M3, and M4 are pMOS, the HI and LOW levels need to be reversed.

The light emitting period in FIG. 9 will be described.

When a current is supplied to the organic EL device A, a LOW-level signal is input to P1, a HI-level signal is input to P2, and a LOW-level signal is input to P3; and M1 is turned OFF, M3 is turned ON, and M4 is turned OFF. At this time, M3 is in a conducting state. Thus, the voltage occurring in C1 causes a current according to the current drive capability of M2 to be supplied to the organic EL device A. Then, the organic EL device A emits light at a luminance according to the supplied current. During the period when P2 is in HI-level, the organic EL device A emits light, and the integrated light quantity is treated as the luminance of the organic EL device A.

When a current is supplied to the organic EL device B, a LOW-level signal is input to P1, a LOW-level signal is input to P2, and a HI-level signal is input to P3; and M1 is turned OFF, M3 is turned OFF, and M4 is turned ON. At this time, M4 is in a conducting state. Thus, the voltage occurring in C1 causes a current according to the current drive capability of M5 to be supplied to the organic EL device B. Then, the organic EL device B emits light at a luminance according to the supplied current. During the period when P3 is in HI-level, the organic EL device B emits light, and the integrated light quantity is treated as the luminance of the organic EL device B.

Thus, the present example can perform the above operation of the pixel circuit in FIG. 8 to vary the luminance ratio of each color in the organic EL devices A and B, thereby allowing white balance to be adjusted and the organic EL elements A and B display in the same hue to provide high image quality.

Further, in the present example, it is more preferable to vary the on-time of the organic EL devices A and B of the same color because display according to the user scene is enabled and high image quality can be provided. Examples of the lighting period difference forming unit for varying the on-time of the organic EL devices A and B of the same color in each pixel circuit are P2 and M3, and P3 and M4 in FIG. 8. Hereinafter, the more preferable example will be described.

According to the present example, when the same current is supplied to the organic EL devices A and B to emit light, the front side luminance is such that the sub-pixel containing the organic EL device A: the sub-pixel containing the organic EL device B=1:4 because of the micro lens provided on the light emitting surface side of the organic EL device B. At this time, it is assumed that there are five modes such that current-time product ratios per frame of the organic EL device A and the organic EL device B=4:0, 3:1, 2:2, 1:3, 0:4 (see (a) to (e) in FIG. 9). Considering the front side luminance ratio and the current-time product ratio, the on-time of the organic EL device A and the organic EL device B is set.

First, the description will focus on a case in which the “wide view angle mode” and “power save mode” can be selected. From the front side luminance ratio and the current-time product ratio, the organic EL devices A and B have five on-time ratios: 16:0, 12:1, 8:2, 4:3, and 0:4. The present example has a control unit being separately connected to each of the two organic EL devices emitting light of the same color and separately controlling the turning on and off of each of the two organic EL devices. Thus, ON and OFF of M3 and M4 can be set so as to satisfy the above five on-time ratios. When the device is turned on in this manner, as described in the first embodiment, the “wide view angle mode” and “power save mode” can be selected, and an intermediate state between the “wide view angle mode” and the “power save mode” can also be selected. Thus, high image quality can be provided.

Next, the description will focus on a case in which the “wide view angle mode” and the “outdoor visibility mode” can be selected. From the front side luminance ratio and the current-time product ratio, the organic EL devices A and B have five on-time ratios: 4:0, 3:4, 2:8, 1:12, and 0:16. The present example has a control unit being separately connected to each of the two organic EL devices emitting light of the same color and separately controlling the turning on and off of each of the two organic EL devices. Thus, ON and OFF of M3 and M4 can be set so as to satisfy the above five on-time ratios. When the device is turned on in this manner, as described in the first embodiment, the “wide view angle mode” and “outdoor visibility mode” can be selected, and an intermediate state between the “wide view angle mode” and the “outdoor visibility mode” can also be selected. Thus, high image quality can be provided.

Further, according to the present example, the instantaneous current applied to turn on the organic EL devices A and B is constant, and hence the pixel circuit can drive the organic EL devices A and B by the same current value. Specifically, in a case in which only any one of the organic EL devices A and B emits light as illustrated by (a) and (e) in FIG. 9, the same data signal may be input, thus enabling the dynamic range of the data signal supplied to the organic EL device B to be widened and the S/N ratio to be increased. For (b) to (d) in FIG. 9, the drive current value may be the same value, and hence the pixel circuit can drive both organic EL devices A and B by writing the data signal only one time.

### Second Example

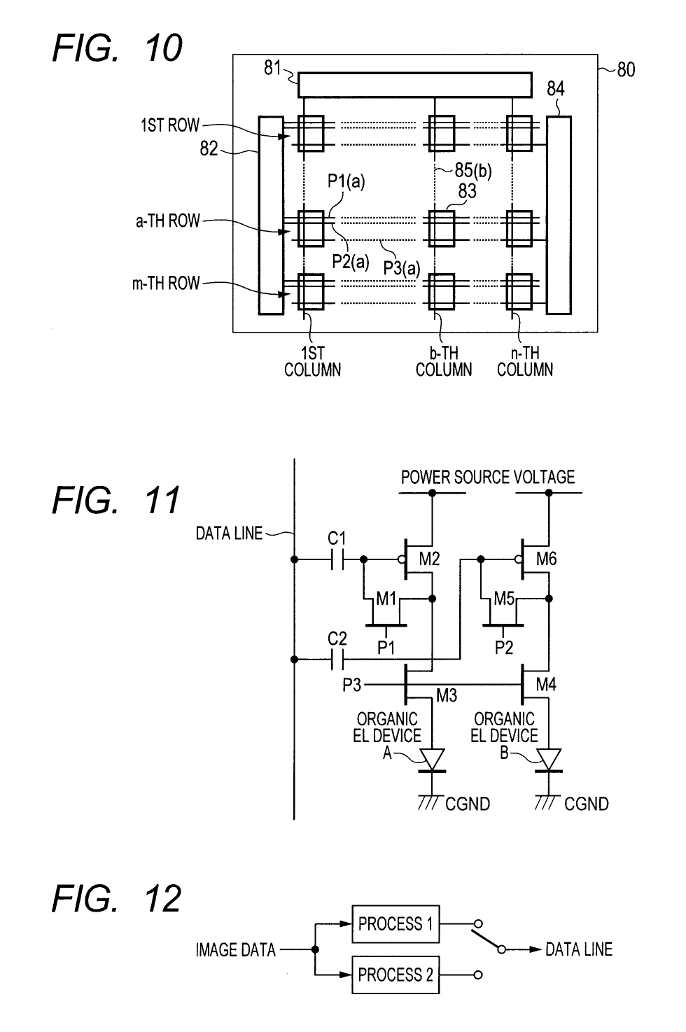

FIG. 10 is a schematic view of an organic EL panel 80 having a plurality of pixels (m-row×n-column pixels) arranged in a matrix and having an organic EL device for each pixel. The organic EL panel 80 is the organic EL panel of the present example. The organic EL panel 80 includes unillustrated organic EL devices, a data line drive circuit 81 (data line driver), a gate line drive circuit 82 (gate line driver), a pixel circuit 83, and a gate line drive circuit 84 (gate line driver). The data line drive circuit 81 applies a data signal to a data line 85. The gate line drive circuit 82 drives gate lines P1 and P2. The pixel circuit 83 is provided for each pixel, has a plurality of transistors, and supplies a drive current to an organic EL device according to the data signal to turn on the organic EL device. The gate line drive circuit 84 drives gate a line (selection control line) P3 in a display region. Each pixel includes two sub-pixels emitting light of R and having different optical characteristics; two sub-pixels emitting light of G and having different optical characteristics; and two sub-pixels emitting light of B and having different optical characteristics. Each of the sub-pixels includes an organic EL device. In FIG. 10, the gate line drive circuit 82 and the gate line drive circuit 84 in a display region are arranged left and right respectively with the pixel group sandwiched therebetween, but one of the circuits may be arranged on one side of left and right sides, or a circuit having the same function may be arranged left and right to be driven from both sides so as to improve the quality of write operation to the pixel. The pixel structure and the pixel arrangement of the display apparatus of the present example are the same as those in FIGS. 7B and 7C, and thus the description thereof will be omitted.

FIG. 11 illustrates a pixel circuit of the present example. The gate lines P1 and P2 are connected to the gate terminal of TFT (M1) and the gate terminal of TFT (M5) respectively. The selection control line P3 of both organic EL devices A and B is connected to the gate terminal of TFT (M3) and the gate terminal of TFT (M4). The data line is connected to one end of the capacitor C1 and one end of the capacitor C2. Voltage data Vdata as a data signal is input from the data line. Different data signals V1 and V2 generated by the data line drive circuit 81 in FIG. 10 are supplied to the one end of the capacitor C1 and the one end of the capacitor C2 from the data line. The anode electrode of the organic EL device A is connected to the source terminal of TFT (M3) and the cathode electrode thereof is connected to the ground voltage CGND. The anode electrode of the organic EL device B is connected to the source terminal of TFT (M4) and the cathode electrode thereof is connected to the ground voltage CGND. The drain terminal of TFT (M3) is connected to the source terminal of TFT (M1) and the drain terminal of TFT (M2), and the source terminal of TFT (M2) is connected to the power source voltage. The drain terminal of TFT (M4) is connected to the source terminal of TFT (M5) and the drain terminal of TFT (M6), and the source terminal of TFT (M6) is connected to the power source voltage. The drain terminal of TFT (M1) is connected to the gate terminal of TFT (M2) and the other end of the capacitor C1. The drain terminal of TFT (M5) is connected to the gate terminal of TFT (M6) and the other end of the capacitor C2.

Here, the description will focus on a unit for generating different data signal Vdata=V1 and V2 by the data line drive circuit 81 in FIG. 10. As the unit for generating different data signals, two processing blocks may be prepared. FIG. 12 illustrates a configuration example of a unit for generating two data signals from a piece of image data. When a piece of image data is input to the two processing blocks, for example, a block of process 1 performs data processing for the organic EL device A to generate a data signal, and a block of process 2 performs data processing for the organic EL device B to generate a data signal. The processing block may use a resistor ladder circuit with the resistance ratio changed for the organic EL device A or for the organic EL device B to perform analog processing to generate the data signal; or may use a DA converter to process data after digital signal processing to generate the data signal. A switch is used to switch between a data signal generated for the organic EL device A and a data signal generated for the organic EL device B, and one of the data signals is output to the data line.

In order to display in the same hue by the organic EL elements A and B, the present example uses the data line drive circuit 81 in FIG. 7A to generate each data signal of the organic EL devices A and B of the same color and to write different signals to the data line 85. Thus, the luminance ratio of each color in the organic EL devices A and B is made to be different from each other. The luminance difference forming unit for varying the luminance ratio of each color of the organic EL devices A and B in the data line drive circuit 81 is a unit in which different data signals are generated and supplied to each gate terminal of a drive transistor provided for each of the organic EL devices A and B of the same color in FIG. 11. The use of different data signals can vary the drive current in each of the organic EL devices A and B, thereby allowing white balance to be adjusted.

The current drive capability ratio of the organic EL devices A and B is the same as described in the first example. In order to obtain a desired white balance, a data signal corresponding to each organic EL device A in the R pixel, the G pixel, and the B pixel is made different from a data signal corresponding to each organic EL device B in the R pixel, the G pixel and the B pixel. The drive current ratio required for the R pixel, the G pixel, and the B pixel is assumed to be IR1:IG1:IB1 for the organic EL device A and IR2:IG2:IB2 for the organic EL device B. In this case, the drive current ratio may be set such that IR1/IR2≠IG1/IG2≠IB1/IB2. At this time, the luminance is such that LR1/LR2≠LG1/LG2≠LB1/LB2. LR1 denotes a luminance of the organic EL device A in the R pixel; LG1 denotes a luminance of the organic EL device A in the G pixel, and LB1 denotes a luminance of the organic EL device A in the B pixel. LR2 denotes a luminance of the organic EL device B in the R pixel; LG2 denotes a luminance of the organic EL device B in the G pixel, and LB2 denotes a luminance of the organic EL device B in the B pixel. Specifically, the luminance ratio of each color in the organic EL devices A and B is made different so as to satisfy LR1/LR2≠LG1/LG2≠LB1/LB2.

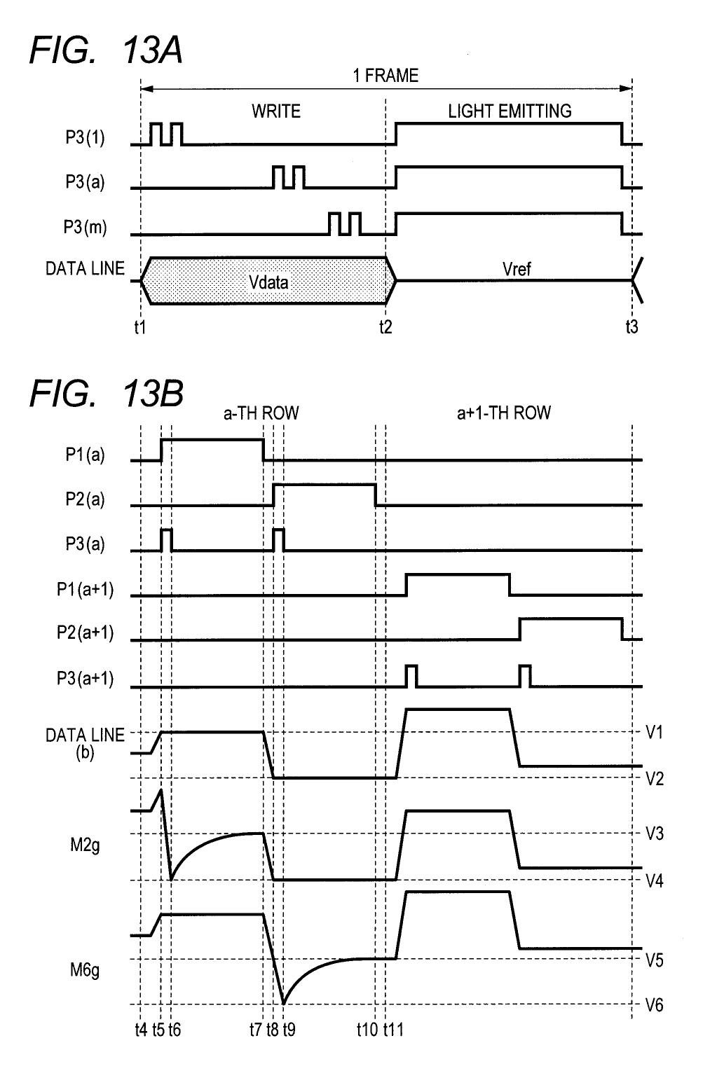

Next, the operation of the pixel circuit in FIG. 11 will be described using a timing chart in FIGS. 13A and 13B. In FIGS. 13A and 13B, the horizontal axis indicates time and the vertical axis indicates ON (HI) and OFF (LOW) of P1 to P3, a voltage of the data line, an M2 gate voltage M2g, and an M6 gate voltage M6g.

FIG. 13A is a timing chart illustrating a write operation and a light emitting operation in a frame. The time from t1 to t2 is assumed be a write period of each row, and the time form t2 to t3 is assumed to be a light emitting period of every row.

First, the write period (t1 to t2) in FIG. 13A will be described. A pulse is output from the gate line drive circuit 82 to P3 as needed so as to perform a write operation for each horizontal period. Two HI pulses are output to a line subjected to a write operation, for example, a-th row, from P3(a). Data signal Vdata is output to the data line. The data signal Vdata is output to the write line from the data line drive circuit 81 in the order of the organic EL device A and the organic EL device B.

Referring to FIG. 13B, the detailed write operation of the pixel circuit will be described.

In the period from t4 to t5, the data signal Vdata=V1 to be written to the organic EL device A is output to the data line.

In the period from t5 to t6, P1(a) and P3(a) enter a HI state, and M1 and M3 enter an ON state. The gate terminal of M2 has the same voltage (V4) as that of the anode electrode of the organic EL device A. At this time, a current flows in the organic EL device A to emit light, but this period is controlled to be at an ignorable level.

In the period from t6 to t7, M3 enters an OFF state. At this time, M1 maintains the ON state, and M2 enters a diode-connected state. In the period from t5 to t6, the M2 gate voltage converges from V4 to a voltage (V3) obtained by subtracting an M2 threshold voltage Vth from the power source voltage (hereinafter referred to as Voled).

In the period from t7 to t8, P1(a) enters a LOW state, and M1 enters an OFF state. At this time, a difference voltage between V1 and Voled-Vth is stored in capacitor C1, and the write operation to the organic EL device A is terminated. Further, the data signal Vdata=V2 to be written to the organic EL device B is output to the data line.

In the period from t8 to t9, P2(a) and P3(a) enter a HI state, and M5 and M4 enter an ON state. The gate terminal of M6 has the same voltage (V6) as that of the anode electrode of the organic EL device B. At this time, a current flows in the organic EL device A to emit light, but this period is controlled to be at an ignorable level.

In the period from t9 to t10, M4 enters an OFF state. At this time, M5 maintains the ON state, and M6 enters a diode-connected state. In the period from t8 to t9, the M6 gate voltage converges from V6 to a voltage (V5) obtained by subtracting an M6 threshold voltage Vth from the power source voltage (hereinafter referred to as Voled).

In the period from t10 to tll, P2(a) enters a LOW state, and M5 enters an OFF state. At this time, a difference voltage between V2 and Voled-Vth is stored in capacitor C2, and the write operation to the organic EL device B is terminated.

In the period from t11 onwards, the process moves to a write period of another row. The data line changes according to the data signal of the target pixel. The M2 gate voltage and the M6 gate voltage change according to the change of the data line, but the potential difference of the capacitors C1 and C2 changes while maintaining the state at the write operation.

Next, the description will focus on the light emitting period (t2 to t3) in FIG. 13A. When the write operation is completed up to the m-th row, P3 (1 to m) of every row outputs HI pulses all at once in the light emitting period. The signal Vdata output to the data line is changed to a fixed voltage Vref. The M2 gate voltage and the M6 gate voltage change according to the write signal to another row while maintaining the potential difference between the capacitor terminals at the write operation, but in a state in which the voltage is fixed to Vref at light emission, the M2 gate voltage and the M6 gate voltage are changed to V3−(V1−Vref) and V5−(V2−Vref) respectively.

The TFT voltage−current characteristics is generally expressed by β(current amplification factor)×(Vgs(gate−inter-source voltage)−Vth)². From this expression, a current Id1 flowing through the organic EL device A is calculated. Then, the M2 gate voltage is (Voled−Vth)−(V1−Vref), and Vgs voltage is Voled−(Voled−Vth−(V1−Vref)), namely, Vgs=Vth+V1−Vref. Accordingly,

Id1=β(current amplification factor)×(V1−Vref)² (Expression 1).

Likewise, a current Id2 flowing through the organic EL device B is such that

Id2=β(current amplification factor)×(V2−Vref)² (Expression 2)

Thus, the present example can perform the above operation of the pixel circuit in FIG. 11 to vary the luminance ratio of each color in the organic EL devices A and B, thereby allowing white balance to be adjusted and the organic EL elements A and B display in the same hue, to provide high image quality.

Further, in the present example, it is more preferable to set the same on-time of the organic EL devices A and B of the same color and to vary the drive current thereof because display according to the user scene is enabled and high image quality can be provided. Specifically, each data signal is generated by the data line drive circuit 81 in FIG. 10 for the organic EL devices A and B of the same color and each different data signal is written to the data line 85 to vary the drive current to be supplied to the organic EL devices A and B of the same color. Each different data signal is generated and supplied to each gate terminal of a drive transistor provided for each of the organic EL devices A and B of the same color. Hereinafter, the more preferable example will be described.

According to the present example, when the same current is supplied to the organic EL devices A and B to emit light, the front side luminance is such that the sub-pixel containing the organic EL device A: the sub-pixel containing the organic EL device B=1:4 because of the micro lens provided on the light emitting surface side of the organic EL device B. At this time, it is assumed that there are five modes in which current-time product ratios per frame of the organic EL device A and the organic EL device B=4:0, 3:1, 2:2, 1:3, 0:4. Considering the front side luminance ratio and the current-time product ratio, the drive current of the organic EL device A and the organic EL device B is set.

First, the description will focus on a case in which the “wide view angle mode” and “power save mode” can be selected. From the front side luminance ratio and the current-time product ratio, the organic EL devices A and B have five drive current ratios: 16:0, 12:1, 8:2, 4:3, and 0:4. The present example includes the unit for generating and supplying a different data signal to each gate terminal of a drive transistor provided for each of the two organic EL devices emitting light of the same color, and hence the data signals V1 and V2 can be set so as to satisfy the aforementioned five drive current ratios. When the device is turned on in this manner, as described in the second embodiment, the “wide view angle mode” and “power save mode” can be selected, and an intermediate state between the “wide view angle mode” and the “power save mode” can also be selected. Thus, high image quality can be provided.

Next, the description will focus on a case in which the “wide view angle mode” and the “outdoor visibility mode” can be selected. From the front side luminance ratio and the current-time product ratio, the organic EL devices A and B have five drive current ratios: 4:0, 3:4, 2:8, 1:12, and 0:16. The present example includes the unit for generating and supplying a different data signal to each gate terminal of a drive transistor provided for each of the two organic EL devices emitting light of the same color, and hence the data signals V1 and V2 can be set so as to satisfy the aforementioned five drive current ratios. When the device is turned on in this manner, as described in the second embodiment, the “wide view angle mode” and “outdoor visibility mode” can be selected, and an intermediate state between the “wide view angle mode” and the “outdoor visibility mode” can also be selected. Thus, high image quality can be provided.

Further, for the process where each TFT threshold includes manufacturing variations, the present example can drive independently of Vth from the above expressions 1 and 2, thus suppressing variations and enabling stable quality drive.

### Third Example

The organic EL panel of the present example is the same as that in FIG. 10. The pixel structure and the pixel arrangement of the display apparatus of the present example are the same as those in FIGS. 7B and 7C, and thus the description thereof will be omitted.

FIG. 14 illustrates the pixel circuit of the present example, which is partially different from the pixel circuit in FIG. 11. The pixel circuit of the present example is different from the pixel circuit in FIG. 11 in that a gate line P1 is connected to a gate terminal of TFT (M5); and TFT (M7), TFT (M8), TFT (M9), TFT (M10), a voltage line Vref1, and a voltage line Vref2 are added thereto. The drain terminal of TFT (M7) is connected to the data line, and the source terminal of TFT (M7) is connected to one end of the capacitor C1. The source terminal of TFT (M8) is connected to the voltage line Vref1, and the drain terminal of TFT (M8) is connected to one end of the capacitor C1. The drain terminal of TFT (M9) is connected to the data line, and the source terminal of TFT (M9) is connected to one end of the capacitor C2. The source terminal of TFT (M10) is connected to the voltage line Vref2, and the drain terminal of TFT (M10) is connected to one end of the capacitor C2. The gate terminal TFT (M7), the gate terminal of TFT (M8), the gate terminal of TFT (M9), and the gate terminal of TFT (M10) is connected to the gate line P1. TFT (M7) and TFT (M8), or TFT (M9) and TFT (M10) operate in a complementary manner such that when one enters an ON state, the other enters an OFF state.

In order to display in the same hue by the organic EL elements A and B, the present example varies the luminance ratio of each color in the organic EL device A and the luminance ratio of each color in the organic EL device B. Specifically, the same data signal is written to the organic EL devices A and B of the same color from the data line 85 in FIG. 7A to vary the luminance ratio of each color in the organic EL devices A and B in each pixel circuit. The luminance difference forming unit for varying the luminance ratio of each color in the organic EL devices A and B in each pixel circuit is the voltages Vref1 and Vref2 applied to the M2 gate terminal and the M6 gate terminal of FIG. 14 respectively. The use of different voltages can vary the drive current in each of the organic EL devices A and B, thereby allowing white balance to be adjusted. The current drive capability ratio, the drive current ratio, and the luminance of the organic EL devices A and B are the same as described in the second example.

Next, the operation of the pixel circuit in FIG. 14 will be described using a timing chart in FIGS. 15A and 15B. In FIGS. 15A and 15B, the horizontal axis indicates time and the vertical axis indicates ON (HI) and OFF (LOW) of P1 and P3, a voltage of the data line, an M2 gate voltage M2g, and an M6 gate voltage M6g.

FIG. 15A is a timing chart illustrating a write operation and a light emitting operation in a frame. The time from t1 up to t2 is a write period of the first row. The time from t2 up to t3 is a light emitting period of the first row and a write period of a row other than the first row. A write operation is sequentially performed from the first row up to the m-th row, followed by a light emitting operation, and then after the m-th row, the operation is sequentially repeated again from the first row. Data signal Vdata is output to the data line.

Referring to FIG. 15B, the detailed write operation of the pixel circuit will be described.

In the period from t4 to t5, the data signal Vdata=V1 is output to the data line.

In the period from t5 to t6, P1(a) and P3(a) enter a HI state, and M1, M3, M4, M5, M7, and M9 enter an ON state. The gate terminal of M2 has the same voltage (V4) as that of the anode electrode of the organic EL device A. The gate terminal of M6 has the same voltage (V6) as that of the anode electrode of the organic EL device B. At this time, a current flows in the organic EL device A and the organic EL device B to emit light, but this period is controlled to be at an ignorable level. Further, one end of each of the capacitors C1 and C2 is such that data signal Vdata=V1.

In the period from t6 to t7, M3 and M4 enter an OFF state. At this time, M1 and M5 maintain the ON state, and M2 and M6 enter a diode-connected state. In the period from t5 to t6, the M2 gate voltage converges from V4 to a voltage (V3) obtained by subtracting an M2 threshold voltage Vth1 from the power source voltage (hereinafter referred to as Voled). The M6 gate voltage converges from V4 to a voltage (V5) obtained by subtracting an M6 threshold voltage Vth2 from the power source voltage (hereinafter referred to as Voled).

In the period from t7 to t8, P1(a) enters a LOW state, and M1, M5, M7, and M9 enter an OFF state. At this time, a difference voltage between V1 and Voled-Vth1 is stored in capacitor C1, and the write operation to the organic EL device A is terminated. At the same time, a difference voltage between V1 and Voled-Vth2 is stored in capacitor C2, and the write operation to the organic EL device B is terminated as well. Further, since M8 and M10 enter an ON state, one end of the capacitor C1 is a voltage Vref1 and one end of the capacitor C2 is a voltage Vref2. The potential difference of the capacitors C1 and C2 changes while maintaining the state at the write operation. As a result, the M2 gate voltage and the M6 gate voltage are V3−(V1−Vref1) and V5−(V1−Vref2) respectively.

In the period from t8 onwards, P3(a) enters a HI state and a-th row is subjected to the light emitting operation. Then, the process moves to a write period of another row (a+1-th row).

The TFT voltage−current characteristics is generally expressed by p (current amplification factor)×(Vgs(gate−inter-source voltage)−Vth)². From this expression, a current Id1 flowing through the organic EL device A is calculated. Then, the M2 gate voltage is Vg=(Voled−Vth1)−(V1−Vref1), and Vgs voltage is Voled−(Voled−Vth1−(V1−Vref)), namely, Vgs=Vth1+V1−Vref. Accordingly,

Id1=β×(V1−Vref1)² (Expression 3)

Likewise, a current Id2 flowing through the organic EL device B is such that

Id2=β×(V1−Vref2)² (Expression 4)

Thus, the present example can perform the above operation of the pixel circuit in FIG. 14 to vary the luminance ratio of each color in the organic EL devices A and B, thereby allowing white balance to be adjusted and the organic EL elements A and B display in the same hue, to provide high image quality.

Further, in the present example, it is more preferable to set the same on-time of the organic EL devices A and B of the same color and to vary the drive current thereof because display according to the user scene is enabled and high image quality can be provided. Specifically, the same data signal is written to the organic EL devices A and B of the same color from the data line 85 in FIG. 10 to vary the drive current to be supplied to the organic EL devices A and B of the same color in each pixel circuit. A different voltage (reference voltage) can be supplied to each gate terminal of a drive transistor provided for each of the organic EL devices A and B of the same color. Hereinafter, the more preferable example will be described.

According to the present example, when the same current is supplied to the organic EL devices A and B to emit light, the front side luminance is such that the sub-pixel containing the organic EL device A: the sub-pixel containing the organic EL device B=1:4 because of the micro lens provided on the light emitting surface side of the organic EL device B. At this time, it is assumed that there are five modes in which current-time product ratios per frame of the organic EL device A and the organic EL device B=4:0, 3:1, 2:2, 1:3, 0:4. Considering the front side luminance ratio and the current-time product ratio, the drive current of the organic EL device A and the organic EL device B is set.

First, the description will focus on a case in which the “wide view angle mode” and “power save mode” can be selected. From the front side luminance ratio and the current-time product ratio, the organic EL devices A and B have five drive current ratios: 16:0, 12:1, 8:2, 4:3, and 0:4. The present example includes the unit for supplying a different voltage to each gate terminal of a drive transistor provided for each of the two organic EL devices emitting light of the same color, and hence the voltages Vref1 and Vref2 can be set so as to satisfy the aforementioned five drive current ratios. When the device is turned on in this manner, as described in the third embodiment, the “wide view angle mode” and “power save mode” can be selected, and an intermediate state between the “wide view angle mode” and the “power save mode” can also be selected. Thus, high image quality can be provided.

Next, the description will focus on a case in which the “wide view angle mode” and the “outdoor visibility mode” can be selected. From the front side luminance ratio and the current-time product ratio, the organic EL devices A and B have five drive current ratios: 4:0, 3:4, 2:8, 1:12, and 0:16. The present example includes the unit for supplying a different voltage to each gate terminal of a drive transistor provided for each of the two organic EL devices emitting light of the same color, and hence the voltages Vref1 and Vref2 can be set so as to satisfy the aforementioned five drive current ratios. When the device is turned on in this manner, as described in the third embodiment, the “wide view angle mode” and “outdoor visibility mode” can be selected, and an intermediate state between the “wide view angle mode” and the “outdoor visibility mode” can also be selected. Thus, high image quality can be provided.

Further, for the process where each TFT threshold includes manufacturing variations, the present example can drive independently of Vth from the above expressions 3 and 4, thus suppressing variations and enabling stable quality drive.

Since the voltage Vref1 is different from voltage Vref2, even if M2 and M6 write the same current amplification factor β and the same data signal V1, different currents Id1 and Id2 can be applied to the organic EL device A and the organic EL device B respectively.

### Fourth Example

The organic EL panel of the present example is the same as that in FIG. 10. The pixel structure and the pixel arrangement of the display apparatus of the present example are the same as those in FIGS. 7B and 7C, and thus the description thereof will be omitted.

FIG. 16 illustrates the pixel circuit of the present example, which is partially different from the pixel circuit in FIG. 11. The pixel circuit of the present example is different from the pixel circuit in FIG. 11 in that a gate line P1 is connected to a gate terminal of TFT (M5); and a capacitor C3 is connected between the source terminal and the gate terminal of TFT (M6).

In order to display in the same hue by the organic EL elements A and B+, the present example varies the luminance ratio of each color in the organic EL device A and the luminance ratio of each color in the organic EL device B. Specifically, the same data signal is written to the organic EL devices A and B of the same color from the data line 85 in FIG. 7A to vary the luminance ratio of each color in the organic EL devices A and B in each pixel circuit. The luminance difference forming unit for varying the luminance ratio of each color in the organic EL devices A and B in each pixel circuit is the capacitor C3 connected between the source terminal and the gate terminal of TFT (M6) in FIG. 16. The use of a different reduced voltage of the data signal can vary the drive current in each of the organic EL devices A and B, thereby allowing white balance to be adjusted. The current drive capability ratio, the drive current ratio, and the luminance of the organic EL devices A and B are the same as described in the second example.

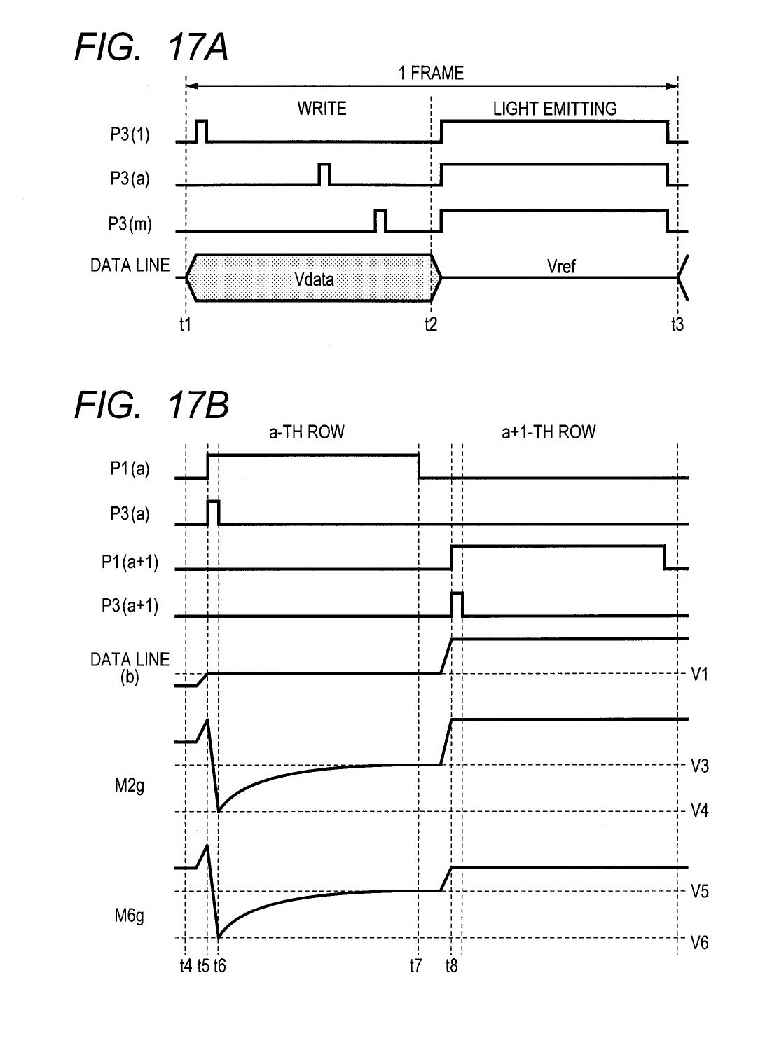

Next, the operation of the pixel circuit in FIG. 16 will be described using a timing chart in FIGS. 17A and 17B. In FIGS. 17A and 17B, the horizontal axis indicates time and the vertical axis indicates ON (HI) and OFF (LOW) of P1 and P3, a voltage of the data line, an M2 gate voltage M2g, and an M6 gate voltage M6g.

FIG. 17A is a timing chart illustrating a write operation and a light emitting operation in a frame. The time from t1 up to t2 is a write period of each row, and the time from t2 up to t3 is a light emitting period of every row.

First, the write period (t1 to t2) in FIG. 17A will be described. A pulse is output to the gate line P3 from the gate line drive circuit 82 as needed so as to perform a write operation for each horizontal period. One HI pulse is output to a line subjected to a write operation, for example, a-th row, from P3(a). Data signal Vdata is output to the data line.

Referring to FIG. 17B, the detailed write operation of the pixel circuit will be described. In the period from t4 to t5, the data signal Vdata=V1 is output to the data line.

In the period from t5 to t6, P1(a) and P3(a) enter a HI state, and TFT(M1), TFT(M3), TFT(M4), and TFT(M5) enter an ON state. The TFT(M2) gate voltage M2g is the same voltage (V4) as that of the anode electrode of the organic EL device A. The TFT(M6) gate voltage M6g is the same voltage (V6) as that of the anode electrode of the organic EL device B. At this time, a current flows in the organic EL device A and the organic EL device B to emit light, but this period is controlled to be at an ignorable level.

In the period from t6 to t7, TFT(M3) and TFT(M4) enter an OFF state. At this time, TFT(M1) and TFT(M5) maintain the ON state, and TFT(M2) and TFT(M6) enter a diode-connected state. In the period from t5 to t6, the gate voltage of TFT(M2) converges from V4 to a voltage (V3) obtained by subtracting a TFT(M2) threshold voltage Vth1 from the power source voltage (hereinafter referred to as Voled). The TFT(M6) gate voltage converges from V4 to a voltage (V5) obtained by subtracting a TFT(M6) threshold voltage Vth2 from the power source voltage (hereinafter referred to as Voled).

In the period from t7 to t8, P1(a) enters a LOW state, and TFT(M1) and TFT(M5) enter an OFF state. At this time, a difference voltage between V1 and Voled−Vth1 is stored in capacitor C1, and the write operation to the organic EL device A is terminated. At the same time, a difference voltage between V1 and Voled−Vth2 is stored in capacitor C2, and the write operation to the organic EL device B is terminated as well.

In the period from t8 onwards, the process moves to a write period of another row. The data line changes according to the data signal of the target pixel. The gate voltages of TFT(M2) and TFT(M6) change according to the change of the data line, but the potential difference of the capacitors C1 and C2 changes while maintaining the state at the write operation.

Next, the description will focus on the light emitting period (t2 to t3) in FIG. 17A. When the write operation is completed up to the m-th row, P3 (1 to m) of every row outputs HI pulses all at once in the light emitting period. The signal data Vdata output to the data line is changed to a fixed voltage Vref. The gate voltages of TFT(M2) and TFT(M6) change according to the write signal to another row while maintaining the potential difference between the capacitor terminals at the write operation, but in a state in which the voltage is fixed to Vref at light emission, each gate voltage is as follows. The gate voltage of TFT(M2) is V3−(V1−Vref), and the gate voltage of TFT(M6) is V5−(V1−Vref)×C2/(C2+C3). Since the capacitor C3 is used, the gate voltage of TFT (M6) is divided by the capacitance ratio between the capacitances of the capacitor C2 and the capacitor C3.

The TFT voltage−current characteristics is generally expressed by β(current amplification factor)×(Vgs(gate−inter-source voltage)−Vth)². From this expression, a current Id1 flowing through the organic EL device A is calculated. Then, the M2 gate voltage is Vg=(Voled−Vth1)−(V1−Vref), and Vgs voltage is Voled−(Voled−Vth1−(V1−Vref)), namely, Vgs=Vth1+V1−Vref. Accordingly,

Id1=β×(V1−Vref)² (Expression 5)

Likewise, a current Id2 flowing through the organic EL device B is such that

Id2=β×{(V1−Vref)×C2/(C2+C3)}² (Expression 6).

Thus, the present example can perform the above operation of the pixel circuit in FIG. 16 to vary the luminance ratio of each color in the organic EL devices A and B, thereby allowing white balance to be adjusted and high image quality to be provided.

Further, for the process where each TFT threshold includes manufacturing variations, the present example can drive independently of Vth from the above expressions 5 and 6, thus suppressing variations and enabling stable quality drive.

Further, the present example includes a capacitor C3 between the gate terminal and the source terminal of TFT (M6). Thus, even if TFT (M2) and TFT (M6) write the same current amplification factor β and the same data signal V1, different currents Id1 and 1d2 can be applied to the organic EL device A and the organic EL device B respectively. Furthermore, a capacitor C4 may be interposed between the gate terminal and the source terminal of TFT (M2) to vary the capacitance ratio of C1/C4 and C2/C3.

Thus, even if the same data signal is input to the pixel circuit, a different current can be applied to each of the organic EL device A and the organic EL device B by setting the capacitor to a desired value. Therefore, the present example can provide a display apparatus which is easy to adjust white balance and having high display quality.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-262295, filed Nov. 25, 2010, which is hereby incorporated by reference herein in its entirety.

What is claimed is:

1. An organic EL display apparatus comprising:
a plurality of pixels arranged in a matrix;
a plurality of organic EL elements arranged in the plurality of pixels;
a data line driver for supplying to each of the plurality of pixels data signal based on an image data;
a plurality of pixel circuits each arranged in each of the plurality of pixels, and having a plurality of transistors for supplying to the organic EL element a driving current based on the data signal to emit light from the organic EL element; and
a gate line driver for driving each of the transistors, wherein
the pixel comprises three or more pairs of the organic EL elements, such that the organic EL elements paired emit light of the same color, while the organic EL elements in different pairs emit lights of the different colors,
the organic EL elements paired includes a first organic EL element having at a light emitting surface side thereof a light condensing element, and a second organic EL element having at the light emitting surface side thereof no light condensing element, and
a luminance ratio difference forming unit is provided for forming a difference between a luminance ratio of the first organic EL element and a luminance ratio of the second organic EL element, in each of the pairs in each of the pixels.

2. The organic EL display apparatus according to claim 1, wherein
the light condensing element is a micro-lens.

3. The organic EL display apparatus according to claim 1, wherein
each of the pixel circuits has a drive transistor for supplying the driving current to the organic EL element, correspondingly to each of the first and second organic EL elements of the same color, and
the luminance ratio difference forming unit comprises the drive transistors having different W/L ratios each for supplying each of the first and second organic EL elements of the same color.

4. The organic EL display apparatus according to claim 1, wherein
each of the pixel circuits has a drive transistor for supplying the driving current to the organic EL element, correspondingly to each of the first and second organic EL elements of the same color, and
the luminance ratio difference forming unit is arranged within the gate line driver, and generates and supplies different data signals to gate terminals of the respective drive transistors.

5. The organic EL display apparatus according to claim 1, wherein
each of the pixel circuits has a drive transistor for supplying the driving current to the organic EL element, correspondingly to each of the first and second organic EL elements of the same color, and
the luminance ratio difference forming unit supplies different voltages to gate terminals of respective gate terminals of respective the drive transistors.

6. The organic EL display apparatus according to claim 1, wherein
each of the pixel circuits has a drive transistor for supplying the driving current to the organic EL element, correspondingly to each of the first and second organic EL elements of the same color, and
the luminance ratio difference forming unit comprises a capacitor having one end connected to the gate of the each of the drive transistor for reducing a voltage of the data signal.

7. The organic EL display apparatus according to claim 3, further comprising
a lighting period difference forming unit for forming a difference between lighting periods of the first and second organic EL elements of the same color.

8. The organic EL display apparatus according to claim 7, wherein
the lighting period difference forming unit is connected to each of the first and second organic EL elements of the same color, for controlling separately the lightings and extinctions of the first and second organic EL elements of the same color.

9. The organic EL display apparatus according to claim 4, further comprising
a driving current difference forming unit for forming a difference between the driving currents supplied to the first and second organic EL elements of the same color.
